(19) United States
(12) Patent Application Publication
(10) Pub. No.: US 2025/0024433 A1
(43) Pub. Date: Jan. 16, 2025

(54) COMMUNICATION METHOD, TERMINAL DEVICE, NETWORK DEVICE, AND COMMUNICATIONS APPARATUS

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN); Cong SHI, Dongguan (CN)

(21) Appl. No.: 18/902,060

(22) Filed: Sep. 30, 2024

Related U.S. Application Data
(63) Continuation of application No. PCT/CN2022/085846, filed on Apr. 8, 2022.

(51) Int. Cl. H04W 72/04; H04L 1/1867

(52) U.S. Cl. CPC H04W 72/04; H04L 1/1887

(57) ABSTRACT

A terminal device, a network device and a communication method are provided. The terminal device includes at least one processor. The at least one processor is configured to: receive first information, where the first information is used to configure a first resource, the first resource is a configured grant CG resource, multiple CG PUSCHs are configured for the first resource in one period; and perform, by the terminal device, data transmission by using at least one of the multiple CG PUSCHs.

### CROSS-REFERENCE TO RELATED APPLICATIONS

This application is a continuation of International Application No. PCT/CN2022/085846, filed on Apr. 8, 2022, the disclosure of which is hereby incorporated by reference in its entirety.

### TECHNICAL FIELD

This application relates to the field of communications technologies, and more specifically, to a communication method, a terminal device, a network device, and a communications apparatus.

### BACKGROUND

Variable-rate services, such as extended reality (XR) and cloud gaming, are introduced into some communications systems (for example, a 5G system). In addition to higher requirements on a latency and reliability, a variable-rate service has a variable data packet size, that is, a variable data rate. In addition, to meet flexible and changeable requirements of users, concurrent transmission of a multi-flow service becomes an inevitable choice in the future.

A data packet size of a service supported in an existing system remains unchanged or substantially unchanged. Therefore, the existing system may not support a variable-rate service and/or a multi-flow service. Therefore, how to meet a transmission requirement of a variable-rate service and/or a multi-flow service needs to be considered.

### SUMMARY

This application provides a communication method, a terminal device, a network device, and a communications apparatus, to support a transmission requirement of a variable-rate service and/or a multi-flow service.

According to a first aspect, a communication method is provided, and includes: receiving, by a terminal device, first information, where the first information is used to configure a first resource, the first resource is a configured grant CG resource or a semi-persistent scheduling SPS resource, multiple transmission resources are configured for the first resource in one period, and/or, the first resource is a dynamic grant DG resource, and downlink control information DCI associated with the DG resource indicates multiple transmission resources; and performing, by the terminal device, data transmission by using at least one of the multiple transmission resources.

According to a second aspect, a communication method is provided, and includes: receiving, by a terminal device, third information, where the third information is used to configure at least one second resource, the second resource is a configured grant CG resource or a semi-persistent scheduling SPS resource, and one transmission resource is configured for the second resource in one period.

According to a third aspect, a communication method is provided, and includes: reporting, by a first node device, auxiliary information, where the auxiliary information is used to indicate feature information of a target service, data, an LCH, a protocol data unit PDU, or a flow; or is used to indicate change information of the feature information of the target service, the data, the LCH, the PDU, or the flow; or is used to indicate changed request information; or is used to indicate that the feature information of the target service, the data, the LCH, the PDU, or the flow changes; or is used to indicate a level of a change of the feature information of the target service, the data, the LCH, the PDU, or the flow; or is used to indicate a rule of the feature information of the target service, the data, the LCH, the PDU, or the flow; or is used to indicate a requested resource configuration, or report data volume information that is expected to be received by a peer end or a network device, or report data volume information that is expected to arrive at a peer end or a network device.

According to a fourth aspect, a communication method is provided, and includes: transmitting, by a network device, first information to a terminal device, where the first information is used to configure a first resource, the first resource is a configured grant CG resource or a semi-persistent scheduling SPS resource, multiple transmission resources are configured for the first resource in one period, and/or, the first resource is a dynamic grant DG resource, and downlink control information DCI associated with the DG resource indicates multiple transmission resources.

According to a fifth aspect, a communication method is provided, and includes: transmitting, by a network device, third information to a terminal device, where the third information is used to configure at least one second resource, the second resource is a configured grant CG resource or a semi-persistent scheduling SPS resource, and one transmission resource is configured for the second resource in one period.

According to a sixth aspect, a terminal device is provided, and includes: a first receiving module, configured to receive first information, where the first information is used to configure a first resource, the first resource is a configured grant CG resource or a semi-persistent scheduling SPS resource, multiple transmission resources are configured for the first resource in one period, and/or, the first resource is a dynamic grant DG resource, and downlink control information DCI associated with the DG resource indicates multiple transmission resources; and a transmitting module, configured to perform data transmission by using at least one of the multiple transmission resources.

According to a seventh aspect, a terminal device is provided, and includes: a first receiving module, configured to receive third information, where the third information is used to configure at least one second resource, the second resource is a configured grant CG resource or a semi-persistent scheduling SPS resource, and one transmission resource is configured for the second resource in one period.

According to an eighth aspect, a communications apparatus is provided, where the communications apparatus is a first node device, and the first node device includes: a reporting module, configured to report auxiliary information, where the auxiliary information is used to indicate feature information of a target service, data, an LCH, a protocol data unit PDU, or a flow; or is used to indicate change information of the feature information of the target service, the data, the LCH, the PDU, or the flow; or is used to indicate changed request information; or is used to indicate that the feature information of the target service, the data, the LCH, the PDU, or the flow changes; or is used to indicate a level of a change of the feature information of the target service, the data, the LCH, the PDU, or the flow; or is used to indicate a rule of the feature information of the target service, the data, the LCH, the PDU, or the flow; or is used to indicate a requested resource configuration, or report data volume information that is expected to be received by a peer end or a network device, or report data volume information that is expected to arrive at a peer end or a network device.

According to a ninth aspect, a network device is provided, and includes: a first transmitting module, configured to transmit first information to a terminal device, where the first information is used to configure a first resource, the first resource is a configured grant CG resource or a semi-persistent scheduling SPS resource, multiple transmission resources are configured for the first resource in one period, and/or, the first resource is a dynamic grant DG resource, and downlink control information DCI associated with the DG resource indicates multiple transmission resources.

According to a tenth aspect, a network device is provided, and includes: a first transmitting module, configured to transmit third information to a terminal device, where the third information is used to configure at least one second resource, the second resource is a configured grant CG resource or a semi-persistent scheduling SPS resource, and one transmission resource is configured for the second resource in one period.

According to an eleventh aspect, a communications apparatus is provided, and includes a processor, a memory, and a communications interface, where the memory is configured to store one or more computer programs, and the processor is configured to invoke the computer program in the memory, to cause the communications apparatus to execute some or all of steps described in the method according to any one of the first aspect to the fifth aspect.

According to a twelfth aspect, an embodiment of this application provides a communications system, where the system includes the foregoing terminal device and/or the foregoing network device. In another possible design, the system may further include another device that interacts with the terminal device or the network device in the solutions provided in embodiments of this application.

According to a thirteenth aspect, an embodiment of this application provides a computer-readable storage medium, where the computer-readable storage medium stores a computer program, and the computer program causes a communications apparatus to execute some or all of steps described in the method according to any one of the first aspect to the fifth aspect.

According to a fourteenth aspect, an embodiment of this application provides a computer program product, where the computer program product includes a non-transitory computer-readable storage medium that stores a computer program, and the computer program is run to cause a communications apparatus to execute some or all of steps described in the method according to any one of the first aspect to the fifth aspect. In some implementations, the computer program product may be a software installation package.

According to a fifteenth aspect, an embodiment of this application provides a chip, where the chip includes a memory and a processor, and the processor may invoke a computer program from the memory and run the computer program, to implement some or all of steps described in a method according to any one of the first aspect to the fifth aspect.

According to embodiments of this application, multiple transmission resources are configured for a first resource in one period, or DCI associated with the first resource indicates multiple transmission resources.

### BRIEF DESCRIPTION OF DRAWINGS

FIG. 1 is a schematic architectural diagram of a wireless communications system that may be applied to embodiments of this application.

FIG. 2 is a schematic flowchart of a communication method according to an embodiment of this application.

FIG. 3 is a schematic flowchart of a communication method according to another embodiment of this application.

FIG. 4 is a schematic flowchart of a communication method according to still another embodiment of this application.

FIG. 5 is a schematic flowchart of a communication method according to yet another embodiment of this application.

FIG. 6 is a schematic flowchart of a communication method according to still yet another embodiment of this application.

FIG. 7 is a schematic structural diagram of a terminal device according to an embodiment of this application.

FIG. 8 is a schematic structural diagram of a terminal device according to another embodiment of this application.

FIG. 9 is a schematic structural diagram of a communications apparatus according to an embodiment of this application.

FIG. 10 is a schematic structural diagram of a network device according to an embodiment of this application.

FIG. 11 is a schematic structural diagram of a network device according to another embodiment of this application.

FIG. 12 is a schematic structural diagram of a communications apparatus according to another embodiment of this application.

### DESCRIPTION OF EMBODIMENTS

The following describes the technical solutions in this application with reference to the accompanying drawings.

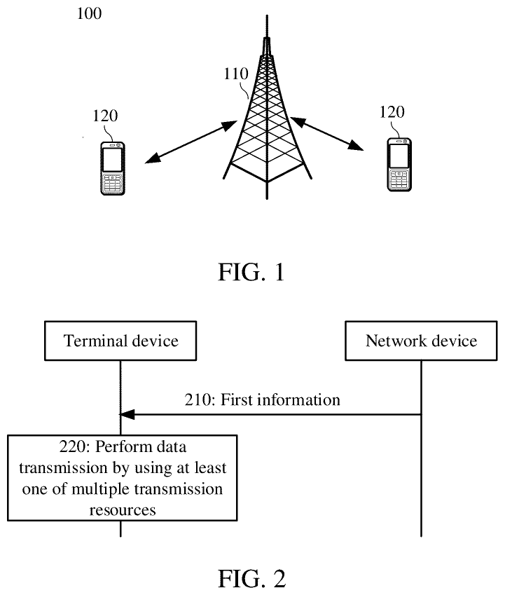

FIG. 1 shows a wireless communications system 100 to which embodiments of this application are applicable. The wireless communications system 100 may include a network device 110 and a terminal device 120. The network device 110 may be a device that communicates with the terminal device 120. The network device 110 may provide communication coverage for a specific geographic area, and may communicate with a terminal device 120 located in the coverage area.

FIG. 1 exemplarily shows one network device and two terminals. In at least one embodiment, the wireless communications system 100 may include multiple network devices, and another quantity of terminal devices may be included in a coverage range of each network device. This is not limited in embodiments of this application.

In at least one embodiment, the wireless communications system 100 may further include another network entity such as a network controller or a mobility management entity, which is not limited in embodiments of this application.

It should be understood that the technical solutions in embodiments of this application may be applied to various communications systems, such as a 5th generation (5G) system or new radio (new radio, NR), a long-term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal device in embodiments of this application may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may refer to a device providing a user with voice and/or data connectivity and being capable of connecting people, objects, and machines, such as a handheld device or vehicle-mounted device having a wireless connection function. The terminal device in embodiments of this application may be a mobile phone (mobile phone), a tablet computer (Pad), a notebook computer, a palmtop computer, a mobile internet device (MID), a wearable device, a virtual reality (VR) device, an augmented reality (augmented reality, AR) device, a wireless terminal in industrial control (industrial control), a wireless terminal in self-driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like. In at least one embodiment, a UE may function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal by using a base station.

The network device in embodiments of this application may be a device for communicating with the terminal device. The network device may also be referred to as an access network device or a radio access network device. For example, the network device may be a base station. The network device in embodiments of this application may refer to a radio access network (RAN) node (or device) that connects the terminal device to a wireless network. The base station may broadly cover various names in the following, or replace with the following names, for example: a NodeB (NodeB), an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. Alternatively, the base station may refer to a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in a future communications system, or the like. The base station may support networks of a same access technology or different access technologies. A specific technology and a specific device used by the network device are not limited in embodiments of this application.

The base station may be fixed or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the network device in embodiments of this application may refer to a CU or a DU, or the network device includes a CU and a DU. A gNB may further include an AAU.

The network device and the terminal device may be deployed on land, including being indoors or outdoors, handheld, or vehicle-mounted; may be deployed on a water surface; or may be deployed on a plane, a balloon, or a satellite in the air. In embodiments of this application, a scenario in which the network device and the terminal device are located is not limited.

It should be understood that all or some of functions of a communications device in this application may also be implemented by software running on hardware, or by virtualization functions instantiated on a platform (for example, a cloud platform).

Some standards or protocols, for example, the 3rd generation partnership project (3GPP), provide increasingly wide and deep support for vertical industries, for example, may support industries such as industry, transportation, energy, medical care, and education. In these industries, industry efficiency may be improved by using new technologies such as sensors, artificial intelligence, and an internet of things and based on advanced mobile networks. In an example, both a 5G system and a 6G system may support vertical industries.

The following describes vertical industries supported by the 5G system by using the 5G system as an example.

Main scenarios in which the 5G system is applicable include: enhanced mobile broadband (eMBB), ultra-reliable low latency communications (URLLC), and massive machine type communications (mMTC). A URLLC may support transmission of services such as factory automation (factory automation), transport automation (transport industry), and electrical power distribution (electrical power distribution) in the 5G system. URLLC has two key features: a low latency and high reliability, that is, URLLC has relatively high requirements on both a latency and reliability. In an application scenario of URLLC, a connection latency may reach 1 millisecond (ms), 0.5 ms, or less, and a high-reliability connection in a case of high-speed movement may be supported. For example, during high-speed movement at a speed of 500 kilometers per hour, reliability may reach 99.999%. Therefore, for a terminal device in the application scenario of URLLC, on the one hand, when a resource is scheduled, a quality of service (QOS) requirement of data transmission of the terminal device needs to be met, for example, a service transmission latency requirement needs to be met. On the other hand, a power consumption requirement of such a terminal device further needs to be met, to avoid unnecessary power consumption. In addition, in consideration of accessing to a network by a large quantity of terminal devices that support URLLC, a network side (for example, a network device) further needs to meet a network capacity requirement when performing resource allocation.

In addition to services in eMBB, URLLC, or mMTC scenarios, new services such as extended reality (XR) and cloud gaming (cloud gaming) are introduced into some communications systems (for example, 5G and 6G systems). Similar to URLLC, an XR service, cloud gaming, and the like all have relatively high requirements on a service latency and reliability. For example, a minimum latency that needs to be supported is 0.5 ms, and reliability may reach 99.999%. In addition, the XR service, cloud gaming, and the like have other features in addition to those of a URLLC service. The following describes the XR service and cloud gaming in detail.

It should be understood that a requirement of the XR service on a system may be understood as consistent with that of cloud gaming. Therefore, in some embodiments, the requirement of the XR service and that of cloud gaming on the system may be referred to as an XR requirement. In other words, the XR requirement may support transmission of services such as the XR service and cloud gaming. It should be further understood that XR may refer to an environment that combines reality and virtuality by using a computer technology and a wearable device, to realize human-computer interaction. The XR service may include an augmented reality (AR) service, a virtual reality (VR) service, a mixed reality (MR) service, and the like.

For the XR service and cloud gaming, a possible service model may include multiple types. The following provides several examples. For example, the XR service is the VR service. A service model of the VR service may be described as follows: the VR service may include posture information of an uplink and video flow information of a downlink. For example, the XR service is the AR service. A service model of the AR service may be described as follows: the AR service may include posture information of an uplink, video flow information of an uplink, and video flow information of a downlink. Cloud gaming is used as an example. A service model of cloud gaming may be described as follows: cloud gaming may include control information of an uplink and video flow information of a downlink.

In some embodiments, the XR service and cloud gaming may have a quasi-period, that is, the XR service and cloud gaming may arrive periodically. Further, in some embodiments, the XR service and cloud gaming may have a pseudo-period, that is, the XR service and cloud gaming may arrive periodically, but a jitter (jitter) occurs at an arrival time of each period of the services. In other words, in each period, the XR service and cloud gaming do not arrive at a fixed time point, but arrive at any time instant within a time range.

In some embodiments, service periods of the XR service and cloud gaming may be integer periods, for example, a period of the posture information of the uplink of the VR service or the AR service and that of the control information of the uplink of cloud gaming are approximately 4 ms. In some embodiments, service periods of the XR service and cloud gaming may be non-integer periods, for example, a period of the video flow information of the downlink of the VR service or cloud gaming, and that of the video flow information of the uplink and the video flow information of the downlink of the AR service are approximately 16.67 ms.

In some embodiments, for the XR service and cloud gaming, in one service period, arrival times of different service flows of a same service may be different, and even a difference between the arrival times may be relatively large. The AR service is used as an example. In one service period, an arrival time of the posture information of the uplink of the AR service is different from that of the video flow information of the uplink of the AR service, and a difference between the arrival times of the posture information and the video flow information is relatively large. For example, a period of the posture information of the uplink is approximately 4 ms, while a period of the video flow information of the uplink is approximately 16.67 ms.

In some embodiments, a data packet size of the XR service and that of cloud gaming are variable, that is, a data rate is variable. Specifically, a data packet size of the XR service and that of cloud gaming may change greatly in each period because the data packet size of the XR service and that of cloud gaming depend on whether a terminal device performs an action. In an example, a data packet size requirement corresponding to the posture information of the uplink of the VR service, that of the AR service, and the control information of the uplink of cloud gaming is approximately 100 bytes (bytes), while a data packet size requirement corresponding to the video flow information of the VR service, that of the AR service, and that of cloud gaming is approximately 0.67 megabits per second (Mbps).

Based on the foregoing descriptions of the XR service and cloud gaming, it may be seen that a data size of such services in each period is variable. Therefore, such services may be referred to as variable-rate services. It should be noted that the XR service and cloud gaming belong to variable-rate services, which is not used to limit that variable-rate services include only these two types. All other services that have similar features may belong to variable-rate services. This is not limited in this application. In some embodiments, both the XR service and cloud gaming are periodic services. Therefore, the XR service and cloud gaming may also be referred to as variable-rate periodic services sometimes.

Concurrent transmission of a multi-flow service may allow a user to use multiple types of services at the same time, for example, browse a web page in a process of a voice call, or download a video in a process of browsing a web page. Therefore, concurrent transmission of a multi-flow service may meet flexible and changeable requirements of the user. Based on this, concurrent transmission of a multi-flow service becomes an inevitable choice in the future. A feature of a multi-flow service is that data transmission may be performed by using different flows concurrently. Data packet sizes corresponding to different flows in the multi-flow service may be variable, or may remain unchanged. Periods of different flows may be the same, or may be different. There may be an association relationship or a dependency relationship between multiple flows, or there may be a requirement for ensuring transmission of all the flows.

In summary, a data packet size of a variable-rate service (such as an XR service or cloud gaming) and/or that of a multi-flow service are variable (for example, data packet sizes in different periods are changeable, or data packet sizes in different flows are changeable), that is, a data rate is variable. However, a data packet size of a service supported in an existing system remains unchanged or substantially unchanged. Therefore, the existing system may not support a variable-rate service and/or a multi-flow service.

To ensure that the existing system can support a variable-rate service and/or a multi-flow service, it is possible to configure a relatively large periodic resource to carry data packets of different sizes. However, in this manner, the resource is wasted and a system capacity is reduced. Therefore, how to meet a requirement of a variable-rate service and/or a multi-flow service needs to be considered in a related technology, to ensure a system capacity while meeting a service transmission requirement.

To resolve the foregoing problem, embodiments of this application provide a communication method, a terminal device, a network device, and a communications apparatus, to ensure a system capacity while meeting a transmission requirement of a variable-rate service and/or a multi-flow service.

Embodiments of this application aim to configure different transmission resources for a terminal device by using a network side, so that the terminal device may perform transmission by using a proper transmission resource according to a data packet size (or a data rate) corresponding to a target service. Based on this, this application provides two embodiments. Embodiment 1 aims to provide multiple or different transmission resources by configuring multiple transmission resources in one period of a first resource. For example, multiple transmission resources are configured for a CG resource in one CG period. In at least one embodiment, one or at least one transmission resource among the multiple transmission resources in the one period may be used. Embodiment 2 aims to provide multiple or different transmission resources by configuring multiple second resources, for example, configuring multiple (multiple) CGs.

To facilitate understanding of the technical solutions in embodiments of this application, the following first describes related technologies of embodiments of this application, and then describes Embodiment 1 and Embodiment 2 one by one in detail. The following related technologies, as optional solutions, may be randomly combined with the technical solutions in embodiments of this application, all of which fall within the protection scope of embodiments of this application.

### Configured Grant

In some communications systems (for example, a 5G system), a network side may configure an uplink grant (grant) for a terminal device, to ensure that the terminal device executes uplink transmission. The uplink grant may be used to indicate some transmission resources (for example, a time domain resource and/or a frequency domain resource), so that the terminal device performs uplink transmission by using the transmission resource. In other words, the uplink grant may be used to indicate transmission of a physical uplink shared channel (PUSCH). In an implementation, the network side may transmit configuration information of the uplink grant to the terminal device, and the configuration information may be carried in, for example, radio resource control (RRC) signalling, medium access control (MAC) signalling, or downlink control information (DCI).

The network side may configure two types of uplink grants. One type of uplink grant may include a dynamic grant (DG), which is also referred to as dynamic scheduling. In an implementation, the dynamic grant may be configured based on a scheduling request (SR) of the terminal device. The other type of uplink grant may include a configured grant (CG). By using a CG, the network side may provide the terminal device with a group of periodically repeated uplink transmission resources. That is, the network side may configure a specific resource period for the terminal device, and a same transmission resource (for example, a time or frequency domain resource) is used for data transmission in each period. In an implementation, the network side may directly configure a CG for the terminal device without a request of the terminal device. In some embodiments, CG-based uplink transmission may also be referred to as grant-free transmission or semi-persistent scheduling (SPS) transmission.

In a related technology, different types of CGs may be supported. An NR system is used as an example. In the NR system, two types of CGs may be supported, and are respectively a configured grant type 1 (CG type1) and a configured grant type2 (CG type2). For the CG type1, a transmission resource (a type is a CG resource) is configured by using RRC signalling, such as a resource period, resource block allocation, and a modulation and coding scheme (modulation and coding scheme, MCS) table. For the CG type2, a transmission resource is configured by using a combination of RRC signalling and DCI signalling. For example, a resource period and an MCS table may be configured by using RRC signalling, and resource block allocation may be indicated by DCI. In addition, when data is to be transmitted, DCI received from the network side dynamically activates transmission resources of the CG type2. When these resources are not required, the transmission resources are deactivated, so that the deactivated transmission resources may be used by another terminal device.

As described above, CG-based uplink transmission may also be referred to as SPS transmission. Therefore, in some embodiments, a downlink resource that is pre-configured or semi-persistently configured may also be referred to as an SPS resource.

### CG Enhancement of URLLC

When data transmission is performed by using a CG, a terminal device is unnecessary to transmit an SR request. Therefore, scheduling signalling overheads can be reduced, and a transmission latency can be reduced. Based on this, a CG may be introduced into a URLLC service to reduce a latency. Further, to meet a high latency requirement of the URLLC service, URLLC may enhance a CG period to support a service period of any slot level (slot-level).

To support multiple types of URLLC services and meet high latency requirements of URLLC services, multiple (multiple) CGs are introduced into URLLC. Hybrid automatic repeat request (HARQ) processes configured for different CGs are different, and a parameter harq-ProcID-Offset2 is used to ensure that processes of different CGs are different.

A network side may activate or deactivate a CG by using RRC signalling or DCI. Further, a single-CG activation manner may be used to active the CG. A single-CG deactivation or CG co-deactivation manner may be used to deactivate the CG.

Due to a conflict between a CG resource and another resource, automatic transmission for a CG is introduced to ensure that MAC protocol data units (protocol data unit, PDU) (for example, low-priority (deprioritized) MAC PDU) that have been packeted in the CG resource are not discarded or are transmitted as soon as possible. For a CG that is of the packeted MAC PDUs and that cannot be transmitted due to a resource conflict, a CG resource in a subsequent or same HARQ process and with a same CG configuration may be used for new transmission. In at least one embodiment, it may be determined, by using an automatic transmission parameter (for example, autonomousTx), that automatic transmission is to be used.

In some embodiments, whether a MAC PDU corresponding to a CG resource is preferentially transmitted may be determined based on a physical layer priority. In a case that physical layer priorities of CGs are different and there is a conflict between different CGs, MAC may indicate one or more MAC PDUs to a physical layer. Similarly, if there is a conflict between data (data) and an SR, MAC may also indicate the SR and a MAC PDU to the physical layer.

In some embodiments, a configured grant retransmission timer (configured grant retransmission timer, CGRT) may be stopped when a low-priority resource appears (for example, logical channel-based prioritization (LCH-based prioritization) and an automatic transmission parameter autonomousTx are configured for the resource).

The following describes in detail the communication methods provided in embodiments of this application with reference to the accompanying drawings. It should be understood that the communication methods provided in embodiments of this application may be applied to data transmission of a variable-rate service and/or a multi-flow service. The variable-rate service may be, for example, an XR service (such as an AR service or a VR service) or cloud gaming.

### Embodiment 1

FIG. 2 is a schematic flowchart of a communication method according to an embodiment of this application. The method shown in FIG. 2 is described from a perspective of interaction between a terminal device and a network device. The terminal device may be, for example, a terminal device 120 shown in FIG. 1, and the network device may be, for example, the network device 110 shown in FIG. 1. The method shown in FIG. 2 may include step S210 and step S220. The following describes these steps in detail.

In step S210, the terminal device receives first information, where the first information is used to configure a first resource.

In some embodiments, the first information is transmitted by the network device, that is, the first resource may be configured by the network device for the terminal device. In an implementation, the first information may be configuration information of an uplink grant, and the network device may transmit the configuration information to the terminal device by using higher layer signalling (for example, RRC signalling, such as RRC reconfiguration or CG-config), MAC signalling, DCI, or the like.

In some embodiments, the first information is determined based on second information. The second information may include feature information of a target service, or data, or an LCH, or a PDU, or a flow, and/or, change information of the feature information of the target service, the data, the LCH, the PDU, or the flow; and/or, a requested resource configuration; and/or, reported data volume information that is expected to be received by a peer end or the network device, and/or reported data volume information that is expected to arrive at a peer end or the network device. The target service may be, for example, the variable-rate service described above, or the target service may be, for example, a multi-flow service. For detailed content of the second information, one may refer to the following description. Details are not described herein again.

In some embodiments, the first resource is a CG resource or an SPS resource, and multiple transmission resources are configured for the first resource in one period. In some other embodiments, the first resource is a DG resource, and DCI associated with the DG resource indicates multiple transmission resources. In some other embodiments, the first resource is a CG resource, and at least one supplementary transmission resource is indicated by DCI. For example, the DCI indicates at least one PUSCH transmission resource except a CG resource position in a CG period. In some other embodiments, the first resource may further include a CG resource and a DG resource. It should be noted that when the first resource is a CG resource or an SPS resource, the first resource generally recurs periodically, and the first information may be used to configure a period, an MCS table, resource block allocation, or the like of the first resource. That is, the network device may configure the period of the first resource for the terminal device, and a same transmission resource may be used by the terminal device in each period, for example, to perform data transmission. Based on this, in a case in which multiple transmission resources are configured for the first resource in one period, multiple transmission resources may be configured for use by the terminal device in each period. The terminal device may use at least one of the resources. It should be noted that at least one of time-frequency resource positions, time-frequency resource sizes, MCSs, or the like of the multiple transmission resources may be the same or may be different.

In embodiments of this application, a value of one period of the first resource is not limited. For example, the value of the one period may be at a second(s) or millisecond (ms) level, for example, the one period is 5 ms. Alternatively, the value of the one period may be at a slot (slot) or symbol (symbol) level, for example, the one period is four slots or the one period is 12 symbols. Alternatively, the one period may be a non-integer period, for example, 16.67 ms.

In some embodiments, the first resource may include a time domain resource and/or a frequency domain resource. In at least one embodiment, the first resource may further include another resource type, for example, a space domain resource.

In some embodiments, the first information may be used to configure multiple (for example, two or more) first resources.

In some embodiments, the first information may be used to configure multiple (for example, two or more) first resources, and data of different flows are transmitted by using different first resources.

In some embodiments, the first resource may be used to carry a data flow of a target service, data, an LCH, or a PDU, and the target service, the data, the LCH, or the PDU is a variable-rate service, variable-rate data, a variable-rate LCH, or a variable-rate PDU, and/or, a multi-flow service, multi-flow data, a multi-flow LCH, or a multi-flow PDU. That is, the first resource may be used to carry a data flow of a variable-rate service or a multi-flow service, or may be used to carry variable-rate data or data of multiple flows. In at least one embodiment, the first resource being used to carry data of multiple flows may include that: different transmission resources (for example, a TB, a PUSCH, and a PDSCH) of the first resource may carry data of different flows in the multiple flows. For example, one TB may carry data of one flow, or one TB may carry data of multiple flows.

In some embodiments, when the first resource is a CG resource, multiple transmission resources configured in the first resource may be CG PUSCHs. When the first resource is an SPS resource, multiple transmission resources configured in the first resource may be SPS physical downlink shared channels (PDSCH). When the first resource is a DG resource, multiple transmission resources indicated by DCI associated with the DG resource may be PUSCHs. In some other embodiments, the first resource is a CG resource, and at least one supplementary transmission resource is indicated by DCI. For example, the DCI indicates at least one PUSCH transmission resource except a CG resource position in a CG period.

In a specific example, the first resource is a CG resource, and the network device may configure the first resource for the terminal device by using the first information, an identifier of the first resource is CG #1, and multiple CG PUSCHs are configured in one period of the first resource CG #1.

When the first resource is a CG resource, a type of the CG resource is not limited in embodiments of this application. For example, the CG resource may be a resource of a CG type1 or a CG type2. In other words, in this embodiment of this application, the first resource may include a resource of the CG type1 and/or a resource of the CG type2. When the first resource includes a resource of the CG type2, the resource of the CG type2 needs to be activated before being used. In another implementation, the first resource may be resources of the CG type1 or the CG type2. In other words, some resources are resources of the CG type1, and some resources are resources of the CG type2. Whether to activate the resources of the CG type2 may be related to the second information, and/or activation or deactivation may be indicated by DCI or a MAC CE.

A type of multiple transmission resources is not specifically limited in embodiments of this application. For example, the multiple transmission resources may be frequency division multiplexing (FDM) resources. Alternatively, the multiple transmission resources may be time division multiplexing (TDM) resources. Alternatively, the multiple transmission resources may further include both an FDM resource and a TDM resource.

In step S220, the terminal device performs data transmission by using at least one of multiple transmission resources.

In some embodiments, in a case in which multiple transmission resources (for example, CG PUSCHs or SPS PDSCHs) are configured in one period, the terminal device may perform data transmission by using only one of the transmission resources. In this case, an unused resource in a current period may be considered invalid. For example, the first information is used to configure a first resource CG #1, and five CG PUSCHs are configured in one period of the first resource CG #1. In this case, the terminal device may use only one CG PUSCH in the CG #1.

In some embodiments, in a case in which multiple transmission resources are configured in one period, the terminal device may perform data transmission by using at least two of the transmission resources. For example, the first information is used to configure a first resource CG #1, and five CG PUSCHs are configured in one period of the first resource CG #1. In this case, the terminal device may use two or more CG PUSCHs in the CG #1.

In this embodiment of this application, multiple transmission resources are configured in one period of a first resource to provide different transmission resources, thereby ensuring a system capacity while meeting a transmission requirement of a variable-rate service and/or a multi-flow service.

In some embodiments, after the terminal device receives multiple transmission resources, the multiple transmission resources correspond to at least one HARQ process ID (ID), that is, each transmission resource in the multiple transmission resources may have a corresponding HARQ process, and the HARQ process of one transmission resource may be the same as or different from that of another transmission resource. In an implementation, in a case in which multiple transmission resources are included in one period of the first resource, the network device may configure multiple HARQ process IDs, so that the multiple transmission resources may correspond to at least one HARQ process ID. It should be understood that, unless otherwise obviously emphasized in this application, a HARQ process ID may also be equivalently replaced with a HARQ process index (index). This manner may be applicable to a case that the first resource is a CG resource or an SPS resource, or may be applicable to a case that the first resource is a DG resource or that the first resource is a CG resource and a DG resource.

In at least one embodiment, the first resource being a CG resource or an SPS resource is used as an example. Multiple CG PUSCHs or multiple SPS PDSCHs are configured in one period of the first resource, and each CG PUSCH or SPS PDSCH may correspond to a same HARQ process or different HARQ processes. Further, the terminal device may use only a HARQ process corresponding to one selected CG PUSCH or SPS PDSCH.

In some embodiments, after the terminal device receives multiple transmission resources, the multiple transmission resources correspond to at least one redundancy version (RV). It should be noted that, for brevity, in the following, a HARQ process and a redundancy version are not separately described, but a HARQ process is used as an example for description. However, the described content may be correspondingly applied to determining of a redundancy version, an indication of a redundancy version, or other related content. Therefore, for content of a redundancy version corresponding to a transmission resource, one may refer to related content of a HARQ process corresponding to the transmission resource.

FIG. 3 is a schematic flowchart of a communication method according to another embodiment of this application. As shown in FIG. 3, in some embodiments, the communication method according to this embodiment of this application may further include step S310 and step S320.

In step S310, a terminal device receives a HARQ configuration or a HARQ indication. The terminal device may determine, based on the HARQ configuration or the HARQ indication, a HARQ process corresponding to multiple transmission resources, or a HARQ process corresponding to multiple transmission resources in one period. In at least one embodiment, the HARQ configuration or the HARQ indication may be transmitted by a network device.

In step S320, the terminal device determines, based on the received HARQ configuration or the received HARQ indication, a HARQ process ID corresponding to multiple transmission resources.

For related content of the HARQ configuration or the HARQ indication, and a manner of how the terminal device determines the HARQ process ID corresponding to the multiple transmission resources, details will be described in the following, and therefore are not described herein again.

In at least one embodiment, the method shown in FIG. 3 may further include step S330. In step S330, the terminal device performs data transmission by using the HARQ process corresponding to the multiple transmission resources.

The following describes the HARQ configuration or the HARQ indication.

In some embodiments, the first information may be used to configure a HARQ process ID set available to a first resource. In an implementation, the first information may include HARQ process IDs included in the HARQ process ID set available to the first resource. For example, the first information includes HARQ processes 0 to 3 (a HARQ process #0, a HARQ process #1, a HARQ process #2, and a HARQ process #3) that are available to the first resource. In another implementation, the first information may include a quantity and/or an offset (offset) of the HARQ process IDs included in the HARQ process ID set available to the first resource. For example, the first information may be used to indicate that the quantity of the HARQ process IDs available to the first resource is 4, and a relative offset is 0. In this case, HARQ processes that are available to the first resource are HARQ processes 0 to 3 (a HARQ process #0, a HARQ process #1, a HARQ process #2, and a HARQ process #3).

In some embodiments, in a case in which multiple transmission resources are configured for a first resource, a quantity of HARQ processes in the prior art may not be enough to support the technical solutions of this application. Based on this, the quantity of HARQ process IDs may be extended. For example, a quantity of HARQ process IDs available to a terminal device in the prior art is 16. In this embodiment of this application, the quantity of the HARQ process IDs available to the terminal device may be extended to 20, 32, 64, or the like.

In some embodiments, the first information may be used to configure HARQ process IDs available to multiple transmission resources in one period. In an implementation, the first information may directly include the HARQ process IDs available to the multiple transmission resources. For example, HARQ processes available to the multiple transmission resources are a HARQ process #0, a HARQ process #1, a HARQ process #2, and the like. In another implementation, the first information may include a HARQ process ID and one or more offsets of a first transmission resource. The first transmission resource is a specific transmission resource in the multiple transmission resources (for example, the first transmission resource or the last transmission resource in the multiple transmission resources) or any transmission resource in the multiple transmission resources. The terminal device may determine, based on the HARQ process ID and the one or more offsets of the first transmission resource, a HARQ process ID of another transmission resource in the multiple transmission resources except the first transmission resource. It should be understood that the first information may also be used to configure a redundancy version corresponding to the multiple transmission resources. The following specifically provides several examples in which the first information includes the HARQ process ID and the one or more offsets of the first transmission resource.

In an example, the first information may include the HARQ process ID of the first transmission resource and an offset of another transmission resource in the multiple transmission resources except the first transmission resource relative to the first transmission resource. The first transmission resource being a 1st transmission resource is used as an example. The first information may include a HARQ process ID of the 1st transmission resource, an offset of the second transmission resource relative to the HARQ process ID of the 1st transmission resource, an offset of the third transmission resource relative to the HARQ process ID of the 1st transmission resource, and the like.

In another example, the first information may include the HARQ process ID of the first transmission resource and a set of offsets of other transmission resources in the multiple transmission resources except the first transmission resource relative to the first transmission resource. The first transmission resource being a 1st transmission resource is still used as an example. The first information may include the HARQ process ID of the 1st transmission resource and an offset set. A HARQ process ID to be selected for another transmission resource in the multiple transmission resources may be determined by the terminal device.

A manner in which the HARQ process ID and the one or more offsets of the first transmission resource are configured is not specifically limited in embodiments of this application. In some embodiments, the HARQ process ID and the one or more offsets of the first transmission resource may be configured by using higher layer signalling (for example, RRC signalling). In some embodiments, the HARQ process ID of the first transmission resource may be configured by using higher layer signalling, and the one or more offsets may be indicated by DCI. In some embodiments, both the HARQ process ID and the one or more offsets of the first transmission resource may be indicated by DCI.

In a specific example, a network device may configure, by using RRC signalling (for example, CG config), a HARQ process ID available to the first transmission resource and an offset of another transmission resource relative to the HARQ process ID of the first transmission resource. In another specific example, a network device may configure, by using RRC signalling (for example, CG config), a HARQ process ID available to the first transmission resource, and indicate, by using DCI, an offset of another transmission resource relative to the HARQ process ID of the first transmission resource. In still another specific example, a network device may configure, by using RRC signalling (for example, CG config), a HARQ process ID available to the first transmission resource, and indicate, by using DCI, a set of offsets of the other transmission resources relative to the HARQ process ID of the first transmission resource. In yet another specific example, a network device may further configure (or indicate), by using RRC signalling or DCI, a HARQ process ID available to each transmission resource in multiple transmission resources.

In some embodiments, the terminal device may transmit first indication information to a network device, where the first indication information is used to indicate a HARQ process ID of multiple transmission resources. In at least one embodiment, this solution may be applied to a case in which HARQ configurations or HARQ indications received by the terminal device are a set, for example, the HARQ configurations or the HARQ indications are a HARQ process ID set available to the first transmission resource.

When HARQ process IDs used by multiple transmission resources in one period are different, the HARQ process IDs of the multiple transmission resources may be determined in multiple manners. This is not specifically limited in this application. When multiple transmission resources are configured in one period, determining a HARQ process ID of the multiple transmission resources can ensure effective service transmission. It should be understood that a solution for determining a HARQ process ID may also be applied to determining a redundancy version.

In some embodiments, the terminal device may determine a HARQ process ID of multiple transmission resources or a HARQ process ID of multiple transmission resources in one period. In at least one embodiment, the terminal device may determine the HARQ process ID of the multiple transmission resources or the HARQ process ID of the multiple transmission resources in the one period based on an implementation of the terminal device. In at least one embodiment, the terminal device may determine the HARQ process ID of the multiple transmission resources or the HARQ process ID of the multiple transmission resources in the one period based on a pre-defined rule. In at least one embodiment, the terminal device may determine the HARQ process ID of the multiple transmission resources or the HARQ process ID of the multiple transmission resources in the one period based on indication information from a network side.

In some embodiments, a HARQ process ID of a first transmission resource in multiple transmission resources in one period is related to a first factor. In at least one embodiment, the first factor may include multiple types, which is not limited in this application. For example, the first factor may include at least one of the following: a quantity of resources (for example, a first resource (such as a CG resource and an SPS resource)) that are concurrently scheduled, a quantity of HARQ processes corresponding to a scheduled resource, a quantity of resources (for example, transmission resources (such as CG PUSCHs and SPS PDSCHs)) in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of logical channels (LCH) (for example, one flow is related to one LCH, or multiple flows are related to one or more LCHs).

In at least one embodiment, the HARQ process ID of the first transmission resource may be further determined based on a first formula. It should be understood that, the first formula varies depending on a type of the first resource. The following describes the first formula by using an example in which the first resource is a CG resource and an SPS resource.

In an example, the first resource is a CG resource and multiple transmission resources (CG PUSCHs) are configured for the CG resource in one period, the first formula is related to one or more of the following items, or the first formula includes at least one of the following items: a quantity of CG PUSCHs in one CG period; a quantity of different HARQ process IDs that are to be used in one CG period; a time domain start position of an uplink CG resource (for example, a time domain start position of the first resource); a quantity of HARQ process IDs of the first transmission resource; an offset of a HARQ process of the first transmission resource; a quantity of HARQ processes of the first resource; or an offset of a HARQ process of the first resource.

In at least one embodiment, when quantities of CG PUSCHs in different periods are the same, the first formula may vary depending on different cases.

In some embodiments, when neither a parameter harq-ProcII)-Offset2 nor a parameter cg-RetransmissionTimer is configured for an uplink CG (For configured uplink grants neither configured with harq-ProcID)-Offset2 nor with cg-Retransmission Timer), HARQ process ID of the first transmission resource=M*{[floor (CURRENT_symbol/periodicity)] modulo nrofHARQ-processes}. Alternatively, when the parameter harq-ProcID-Offset2 is configured for the uplink CG (For configured uplink grants with harq-ProcID)-Offset2), HARQ process ID of the first transmission resource=M*{[floor (CURRENT_symbol/periodicity)] modulo nrofHARQ-processes+harq-procID-Offset2}, where M is the quantity of the CG PUSCHs in the one CG period, or M is the quantity of the different HARQ process IDs that are to be used in the one CG period, CURRENT_symbol is the time domain start position of the uplink CG resource (or the first resource), nrofHARQ-processes is the quantity of the HARQ processes of the first resource, and harq-procID)-Offset2 is the offset of the HARQ process of the first resource.

In some embodiments, HARQ process ID of the first transmission resource=M*{[floor (CURRENT_symbol/periodicity)] modulo nrofHARQ-processes}; or HARQ process ID of the first transmission resource=M*{[floor (CURRENT_symbol/periodicity)] modulo profHARQ-processes harq-procID-Offset2; or HARQ process ID of the first transmission resource={M*{[floor (CURRENT_symbol/periodicity)] modulo nrofHARQ-processes}} modulo nrofHARQ-processes; or HARQ process ID of the first transmission resource={M*{[floor (CURRENT_symbol/periodicity)] modulo nrofHARQ-processes+harq-procID-Offset2}} modulo nrofHARQ-processes; or HARQ process ID of the first transmission resource={M*{[floor (CURRENT_symbol/periodicity)] modulo nrofHARQ-processes}} modulo nrofHARQ-processes+harq-procID)-Offset2, where M is the quantity of the CG PUSCHs in the one CG period, or M is the quantity of the different HARQ process IDs that are to be used in the one CG period, CURRENT_symbol is the time domain start position of the uplink CG resource, or a time domain position of the first transmission resource, nrofHARQ-processes is the quantity of the HARQ processes of the first transmission resource, and harq-procID)-Offset2 is the offset of the HARQ process of the first transmission resource.

In at least one embodiment, if quantities of CG PUSCHs in different periods are different, adaptive modification may be performed on the first formula. For example, in the foregoing, because quantities of CG PUSCHs in all periods are the same (M), a calculation result of {[floor (CURRENT_symbol/periodicity)] modulo nrofHARQ-processes} is multiplied by M. When the quantities of the CG PUSCHs in different periods are different, a calculation result corresponding to each period may be multiplied by a quantity of CG PUSCHs in the period, and then multiplication results are accumulated. For a case in which the parameter harq-ProcII)-Offset2 is configured for the uplink CG, conversion may be performed similarly, and details are not described herein again. In at least one embodiment, HARQ process IDs used by a same repetition (repetition) are the same.

In another example, the first resource is an SPS resource and multiple transmission resources (SPS PDSCHs) are configured for the SPS resource in one period, the first formula is related to one or more of the following items, or the first formula includes at least one of the following items: a quantity of SPS PDSCHs in one SPS period; a quantity of different HARQ process IDs that are to be used in one SPS period; a time domain start position of a downlink SPS resource (the first resource); a quantity of HARQ processes of the first transmission resource; an offset of a HARQ process of the first transmission resource; a quantity of HARQ processes of the first resource; or an offset of a HARQ process of the first resource.

In at least one embodiment, when quantities of SPS PDSCHs in all periods are the same, the first formula may vary depending on different cases.

In some embodiments, when a parameter harq-ProcII)-Offset is not configured for a downlink SPS (For configured downlink assignments without harq-ProcID)-Offset), HARQ process ID of the first transmission=M*{[floor (CURRENT_slot×10/(numberOfSlotsPerFrame×periodicity))] modulo nrofHARQ-processes}. Alternatively, when the parameter harq-ProcII)-Offset is configured for the downlink SPS (For configured downlink assignments with harq-ProcID-Offset), HARQ process ID of the first transmission resource=M*{[floor (CURRENT_slot×10/(numberOfSlotsPerFrame×periodicity))] modulo nrofHARQ-processes+harq-procID-Offset}, where M is the quantity of the SPS PDSCHs in the one SPS period, or M is a quantity of different HARQ processes that are to be used in one SPS period, CURRENT_slot is the time domain start position of the downlink SPS resource (the first resource), numberOfSlotsPerFrame is a quantity of slots included in one system frame, nrofHARQ-processes is the quantity of the HARQ processes of the first resource, and harq-procID)-Offset is the offset of the HARQ process of the first resource.

In some embodiments, HARQ process ID of the first transmission resource=M*{[floor (CURRENT_slot×10/(numberOfSlotsPerFrame×periodicity))] modulo nrofHARQ-processes}; or HARQ process ID of the first transmission resource=M*{[floor (CURRENT_slot×10/(numberOfSlotsPerFrame×periodicity))] modulo nrofHARQ-processes+harq-procII)-Offset}; or HARQ process ID of the first transmission resource={M*{[floor (CURRENT_slot×10/(numberOfSlotsPerFrame×periodicity))] modulo nrofHARQ-processes}} modulo nrofHARQ-processes; or HARQ process ID of the first transmission resource=M*{[floor (CURRENT_slot×10/(numberOfSlotsPerFrame×periodicity)] modulo nrofHARQ-processes+harq-procID-Offset}} modulo nrofHARQ-processes; or HARQ process ID of the first transmission resource={M*{[floor (CURRENT_slot×10/(numberOfSlotsPerFrame×periodicity))] modulo nrofHARQ-processes}} modulo nrofHARQ-processes+harq-procID)-Offset, where M is the quantity of the SPS PDSCHs in the one SPS period, or M is the quantity of the different HARQ process IDs that are to be used in the one SPS period, CURRENT_slot is the time domain start position of the downlink SPS resource, or a time domain position of the first transmission resource, nrofHARQ-processes is the quantity of the HARQ processes of the first transmission resource, and harq-procID-Offset is the offset of the HARQ process of the first transmission resource.

In at least one embodiment, if quantities of SPS PDSCHs in different periods are different, adaptive modification may be performed on the first formula. For example, in the foregoing, because quantities of SPS PDSCHs in all periods are the same (M), a calculation result of {[floor (CURRENT_slot×10/(numberOfSlotsPerFrame×periodicity))] modulo nrofHARQ-processes+harq-procII)-Offset} is multiplied by M. When the quantities of the SPS PDSCHs in different periods are different, a calculation result corresponding to each period may be multiplied by a quantity of SPS PDSCHs in the period, and then multiplication results are accumulated. For a case in which the parameter harq-ProcID-Offset is configured for an uplink SPS, conversion may be performed similarly, and details are not described herein again. In at least one embodiment, HARQ process IDs used by a same repetition (repetition) are the same.

After the HARQ process ID of the first transmission resource is obtained through calculation according to the first formula, a HARQ process ID of another transmission resource in multiple transmission resources except the first transmission resource in one period may be obtained based on the HARQ process ID of the first transmission resource. This is described in detail in the following.

In some embodiments, after the HARQ process ID of the first transmission resource is obtained through calculation according to the first formula, the terminal device may determine a HARQ process ID of another transmission resource based on a HARQ configuration or a HARQ indication. This method may be applicable to a case in which HARQ configurations or HARQ indications are a set.

In at least one embodiment, the terminal device may determine a HARQ process ID of another transmission resource based on an implementation of the terminal device or a pre-defined rule or network indication information.

In at least one embodiment, after the terminal device determines the HARQ process ID of the another transmission resource, the terminal device may transmit second indication information to a network device, where the second indication information is used to indicate a HARQ process ID of another transmission resource in multiple transmission resources except the first transmission resource.

In some other embodiments, after the HARQ process ID of the first transmission resource is obtained through calculation according to the first formula, a HARQ process ID of another transmission resource in multiple transmission resources except the first transmission resource in one period may be determined based on a second factor, or the HARQ process ID of the another transmission resource is obtained through calculation according to a second formula.

In at least one embodiment, the HARQ process ID of the another transmission resource is related to the second factor. In at least one embodiment, the second factor may include multiple types, which is not limited in this application. For example, the second factor may include at least one of the following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of LCHs (for example, one flow is related to one LCH, or multiple flows are related to one or more LCHs).

In at least one embodiment, the HARQ process ID of the another transmission resource in the multiple transmission resources except the first transmission resource is the HARQ process ID of the first transmission resource plus an offset of the another transmission resource relative to the first transmission resource.

It should be understood that the second formula also varies depending on a type of the first resource. The following describes the second formula by using an example in which the first resource is a CG resource and an SPS resource.

In an example, the first resource is a CG resource and multiple transmission resources (CG PUSCHs) are configured for the CG resource in one period, the second formula is related to one or more of the following items, or the second formula includes at least one of the following items: a quantity of CG PUSCHs in one CG period; a quantity of different HARQ process IDs that are to be used in one CG period; a time domain start position of an uplink CG resource (for example, a time domain start position of the first resource); a quantity of HARQ processes of the first resource; an offset of a HARQ process of the first resource; a quantity of HARQ process IDs of the first transmission resource; an offset of a HARQ process of the first transmission resource; or an offset of another transmission resource relative to the first transmission resource.

In at least one embodiment, when quantities of CG PUSCHs in all periods are the same, the second formula may vary depending on different cases.

In some embodiments, when neither a parameter harq-ProcID-Offset2 nor a parameter cg-RetransmissionTimer is configured for an uplink CG (For configured uplink grants neither configured with harq-ProcID)-Offset2 nor with cg-RetransmissionTimer), HARQ process ID of the another transmission resource=M*{[floor (CURRENT_symbol/periodicity)] modulo nrofHARQ-processes}+offset N. Alternatively, when the parameter harq-ProcII)-Offset2 is configured for the uplink CG (For configured uplink grants with harq-ProcID)-Offset2), HARQ process ID of the another transmission resource=M*{[floor (CURRENT_symbol/periodicity)] modulo nrofHARQ-processes+harq-procID-Offset2}+offset N, where M is the quantity of the CG PUSCHs in the one CG period, or M is the quantity of the different HARQ process IDs that are to be used in the one CG period, CURRENT_symbol is the time domain start position of the uplink CG resource (or the first resource), nrofHARQ-processes is the quantity of the HARQ processes of the first resource, harq-procID)-Offset2 is the offset of the HARQ process of the first resource, and offset N is the offset of the another transmission resource relative to the first transmission resource.

In some embodiments, HARQ Process ID of the another transmission resource=M*{[floor (CURRENT_symbol/periodicity)] modulo nrofHARQ-processes}+offset N; or HARQ Process ID of the another transmission resource=M*{[floor (CURRENT_symbol/periodicity)] modulo nrofHARQ-processes+harq-procID-Offset2}+offset N; or HARQ process ID of the another transmission resource={M*{[floor (CURRENT_symbol/periodicity)] modulo nrofHARQ-processes}} modulo nrofHARQ-processes+offset N; or HARQ process ID of the another transmission resource={M*{[floor (CURRENT_symbol/periodicity)] modulo nrofHARQ-processes+harq-procID-Offset2}} modulo nrofHARQ-processes+offset N; or HARQ the =process ID of another transmission resource={M*{[floor (CURRENT_symbol/periodicity)] modulo nrofHARQ-processes}} modulo nrofHARQ-processes+harq-procID-Offset2+offset N; or HARQ Process ID of the another transmission resource={M*{[floor (CURRENT_symbol/periodicity)] modulo nrofHARQ-processes}+offset N} modulo nrofHARQ-processes; or HARQ Process ID of the another transmission resource={M*{[floor (CURRENT_symbol/periodicity)] modulo nrofHARQ-processes+harq-procID-Offset2}+offset N} modulo nrofHARQ-processes; or HARQ process ID of the another transmission resource={{M*{[floor (CURRENT_symbol/periodicity)] modulo nrofHARQ-processes}} modulo nrofHARQ-processes+offset N} modulo nrofHARQ-processes; or HARQ process ID of the another transmission resource={{M*{[floor (CURRENT_symbol/periodicity)] modulo nrofHARQ-processes+harq-procII)-Offset2}} modulo nrofHARQ-processes+offset N} modulo nrofHARQ-processes; or HARQ process ID of the another transmission resource={{M*{[floor (CURRENT_symbol/periodicity)] modulo nrofHARQ-processes}} modulo nrofHARQ-processes+harq-procID-Offset2+offset N} modulo nrofHARQ-processes, where M is the quantity of the CG PUSCHs in the one CG period, or M is the quantity of the different HARQ process IDs that are to be used in the one CG period, CURRENT_symbol is the time domain start position of the uplink CG resource, or a time domain position of the first transmission resource, nrofHARQ-processes is the quantity of the HARQ processes of the first transmission resource, harq-proclD)-Offset2 is the offset of the HARQ process of the first transmission resource, and offset N is the offset of the another transmission resource relative to the first transmission resource.

In at least one embodiment, if quantities of CG PUSCHs in different periods are different, adaptive modification may be performed on the second formula. For example, in the foregoing, because quantities of CG PUSCHs in all periods are the same (M), a calculation result of {[floor (CURRENT_symbol/periodicity)] modulo nrofHARQ-processes} is multiplied by M. When the quantities of the CG PUSCHs in different periods are different, a calculation result corresponding to each period may be multiplied by a quantity of CG PUSCHs in the period, and then multiplication results are accumulated. For a case in which the parameter harq-Procll)-Offset2 is configured for the uplink CG, conversion may be performed similarly, and details are not described herein again. In at least one embodiment, HARQ process IDs used by a same repetition (repetition) are the same.

In another example, the first resource is an SPS resource and multiple transmission resources (SPS PDSCHs) are configured for the SPS resource in one period, the second formula is related to one or more of the following items, or the second formula includes at least one of the following items: a quantity of SPS PDSCHs in one SPS period; a quantity of different HARQ process IDs that are to be used in one SPS period; a time domain start position of a downlink SPS resource (the first resource); a quantity of HARQ processes of the first resource; an offset of a HARQ process of the first resource; a quantity of HARQ process IDs of the first transmission resource; an offset of a HARQ process of the first transmission resource; or an offset of another transmission resource relative to the first transmission resource.

In at least one embodiment, when quantities of SPS PDSCHs in all periods are the same, the second formula may vary depending on different cases.

In some embodiments, when a parameter harq-ProcID-Offset is not configured for a downlink SPS (For configured downlink assignments without harq-ProcID-Offset), HARQ process ID of the another transmission resource=M*{[floor (CURRENT_slot×10/(numberOfSlotsPerFrame×periodicity)] modulo nrofHARQ-processes}+offset N. Alternatively, when the parameter harq-ProcID)-Offset is configured for the downlink SPS (For configured downlink assignments with harq-ProcID-Offset), HARQ process ID of the another transmission resource=M*{[floor (CURRENT_slot×10/(numberOfSlotsPerFrame×periodicity))] modulo nrofHARQ-processes+harq-procID-Offset}+offset N, where M is the quantity of the SPS PDSCHs in the one SPS period, or M is a quantity of different HARQ processes that are to be used in one SPS period, CURRENT_slot is the time domain start position of the downlink SPS resource (the first resource), numberOfSlotsPerFrame is a quantity of slots included in one system frame, nrofHARQ-processes is the quantity of the HARQ processes of the first resource, harq-procID-Offset is the offset of the HARQ process of the first resource, and offset N is the offset of the another transmission resource relative to the first transmission resource.

In some embodiments, HARQ process ID of the another transmission resource=M*{[floor (CURRENT_slot×10/(numberOfSlotsPerFrame×periodicity))] modulo nrofHARQ-processes}+offset N; or HARQ process ID of the another transmission resource=M*{[floor (CURRENT_slot×10/(numberOfSlotsPerFrame×periodicity))] modulo nrofHARQ-processes+harq-procID-Offset}+offset N; or HARQ process ID of the another transmission resource={M*{[floor (CURRENT_slot×10/(numberOfSlotsPerFrame×periodicity))] modulo nrofHARQ-processes}} modulo nrofHARQ-processes+offset N; or HARQ process ID of the another transmission resource={M*{[floor (CURRENT_slot×10/(numberOfSlotsPerFrame×periodicity))] modulo nrofHARQ-processes+harq-procID-Offset}} modulo nrofHARQ-processes+offset N; or HARQ process ID of the another transmission resource={M*{[floor (CURRENT_slot×10/(numberOfSlotsPerFrame×periodicity))] modulo nrofHARQ-processes}} modulo nrofHARQ-processes+harq-procID)-Offset+offset N; or HARQ process ID of the another transmission resource×{M*{[floor (CURRENT_slot 10/(numberOfSlotsPerFrame×periodicity))] modulo nrofHARQ-processes}+offset N} modulo nrofHARQ-processes; or HARQ process ID of the another transmission resource={M*{[floor (CURRENT_slot×10/(numberOfSlotsPerFrame×periodicity))] modulo nrofHARQ-processes+harq-procID-Offset}+offset N} modulo nrofHARQ-processes; or HARQ process ID of the another transmission resource {{M*{[floor (CURRENT_slot×10/(numberOfSlotsPerFrame×periodicity))] modulo nrofHARQ-processes}} modulo nrofHARQ-processes+offset N} modulo nrofHARQ-processes; or HARQ process ID of the another transmission resource={{M*{[floor (CURRENT_slot×10/(numberOfSlotsPerFrame×periodicity))] modulo nrofHARQ-processes+harq-procID-Offset}} modulo nrofHARQ-processes+offset N} modulo nrofHARQ-processes; or HARQ process ID of the another transmission resource={{M*{[floor (CURRENT_slot×10/(numberOfSlotsPerFrame×periodicity))] modulo nrofHARQ-processes}} modulo nrofHARQ-processes+harq-procID-Offset+offset N} modulo nrofHARQ-processes, where M is the quantity of the SPS PDSCHs in the one SPS period, or M is a quantity of different HARQ processes that are to be used in one SPS period, CURRENT_slot is the time domain start position of the downlink SPS resource, or a time domain position of the first transmission resource, numberOfSlotsPerFrame is a quantity of slots included in one system frame, nrofHARQ-processes is the quantity of the HARQ processes of the first transmission resource, harq-procID)-Offset is the offset of the HARQ process of the first transmission resource, and offset N is the offset of the another transmission resource relative to the first transmission resource.

In at least one embodiment, if quantities of SPS PDSCHs in different periods are different, adaptive modification may be performed on the second formula. For example, in the foregoing, because quantities of SPS PDSCHs in all periods are the same (M), a calculation result of {[floor (CURRENT_slot×10/(numberOfSlotsPerFrame×periodicity))] modulo nrofHARQ-processes+harq-procII)-Offset} is multiplied by M. When the quantities of the SPS PDSCHs in different periods are different, a calculation result corresponding to each period may be multiplied by a quantity of SPS PDSCHs in the period, and then multiplication results are accumulated. For a case in which the parameter harq-ProcID-Offset is configured for an uplink SPS, conversion may be performed similarly, and details are not described herein again. In at least one embodiment, HARQ process IDs used by a same repetition (repetition) are the same.

In some embodiments, multiple transmission resources in one period correspond to a same HARQ process ID. In other words, in a case in which multiple transmission resources are configured in one period and the transmission resources correspond to a same HARQ process or different HARQ processes, the terminal device may use only a HARQ process corresponding to a selected transmission resource.

In some embodiments, when multiple transmission resources correspond to a same HARQ process ID, the same HARQ process ID may be determined by the terminal device based on a first resource position. In at least one embodiment, the first resource position may include multiple types. For example, the first resource position may include one or more of the following resource positions: the first resource position of the first resource in one period, the last resource position of the first resource in one period, a specific resource position (for example, any resource position) of the first resource in one period, or a resource position used for actual transmission of the first resource in one period.

That is, in a case in which multiple transmission resources are configured in one period, the terminal device may use only one of the transmission resources, and determine a HARQ process ID corresponding to the transmission resource, thereby reducing complexity.

In some embodiments, if multiple transmission resources correspond to different HARQ process IDs, HARQ process IDs obtained through calculation according to different resource positions may be different. In this case, a HARQ process to be finally used by the terminal device depends on a transmission resource finally used by the terminal device.

In some embodiments, after receiving the HARQ configuration or the HARQ indication, the terminal device determines a HARQ process corresponding to a first resource, and performs transmission. In at least one embodiment, in one period of the first resource, multiple transmission resources are configured, and the terminal device may use only one of the transmission resources. In at least one embodiment, in one period of the first resource, multiple transmission resources are configured, and the transmission resources correspond to a same HARQ process or different HARQ processes. The terminal device may use only a HARQ process corresponding to one selected transmission resource. In at least one embodiment, in one period of the first resource, multiple transmission resources are configured. The terminal device may calculate a HARQ process ID according to a position of each transmission resource or a position of a specific transmission resource (for example, a position of the first transmission resource or a position of the last transmission resource) in the one period.

It should be noted that, in the foregoing descriptions, how to determine a HARQ process ID of multiple transmission resources is described by using an example in which the first resource is a CG resource or an SPS resource. However, this embodiment of this application is not limited thereto. For example, the foregoing method for determining a HARQ process ID of multiple transmission resources is also applicable to a case of dynamic scheduling, for example, a case in which multiple PUSCHs are scheduled but a HARQ process of each PUSCH is not indicated, and HARQ processes of at least one PUSCH are different. In at least one embodiment, the foregoing method may also be applied to a case how the terminal device determines a HARQ process ID of multiple DG resources when a network indicates multiple DGs for use by the terminal device. In a specific implementation, DCI may be used to indicate a HARQ process of a PUSCH at the first position in multiple PUSCHs, and a HARQ process of a PUSCH at another position may be determined based on an offset indicated by RRC or DCI. In another specific implementation, DCI may be used to indicate a HARQ process of a PUSCH at each position in multiple PUSCHs. For example, the foregoing method for determining a HARQ process ID of multiple transmission resources is also applicable to a case with both CG scheduling and dynamic scheduling, for example, a HARQ process is determined when multiple PUSCHs are scheduled. In an implementation, a HARQ process of a DG may be an offset of a CG HARQ process. In another implementation, DCI may indicate a HARQ process ID of each DG.

### Embodiment 2

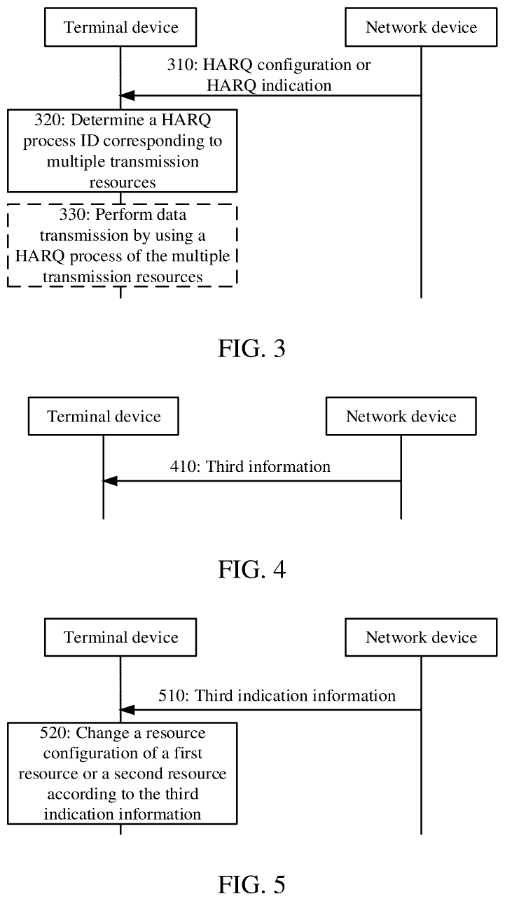

FIG. 4 is a schematic flowchart of a communication method according to still another embodiment of this application. The method shown in FIG. 4 may include step S410. In step S410, a terminal device receives third information, where the third information is used to configure at least one second resource. The second resource is a CG resource or an SPS resource, and one transmission resource is configured for the second resource in one period.

In some embodiments, the third information is transmitted by a network device. In other words, the second resource may be configured by the network device for the terminal device, for example, by using RRC signalling, MAC signalling, DCI signalling, or the like.

In some embodiments, the third information may be determined based on second information. For specific content of the second information, one may refer to the following. Details are not described herein again.

In some embodiments, when multiple groups of second resources are configured for the terminal device, a quantity of indexes or HARQ process IDs of the existing second resources may not be enough to support the technical solutions in embodiments of this application. In an implementation, the quantity of the indexes or the HARQ process IDs of the existing second resources may be extended. For example, a quantity of indexes of second resources (for example, CG resources) available to a terminal device in the prior art is 12. In this embodiment of this application, the quantity of the indexes of the second resources available to the terminal device may be extended to 16, 24, or the like. Alternatively, for example, a quantity of HARQ process IDs available to a terminal device in the prior art is 16. In this embodiment of this application, the quantity of the HARQ process IDs available to the terminal device may be extended to 20, 32, 64, or the like.

In a specific example, the second resource is a CG resource, and a network device may configure multiple second resources for the terminal device by using the third information. Identifiers of the multiple second resources are CG #1, CG #2, CG #3, and the like. In addition, one CG PUSCH is configured in one period of the second resource CG #1, and configurations of the CG #2 and the CG #3 are similar to that of the CG #1.

That is, a difference between the second resource and a first resource lies in that only one transmission resource is configured in one period of the second resource. For other content of the second resource, one may refer to the foregoing descriptions of the first resource. Details are not described herein again.

Different from Embodiment 1, in Embodiment 2, only one transmission resource is configured in one period, but multiple groups of second resources may be configured, for example, multiple (multiple) CGs are configured. The multiple groups of second resources may correspond to, for example, different periods, different resource block allocation, or the like.

According to the solution provided in Embodiment 2 of this application, multiple groups of second resources are provided, so that a terminal device can implement data transmission of a variable-rate service and/or a multi-flow service.

In at least one embodiment, a network configures an association between multiple groups of second resources. For example, the network indicates that multiple second resources are associated with each other. Alternatively, the network configures a second resource group, and the second resource group includes multiple second resources. In at least one embodiment, there is an association or a mapping limitation relationship between a second resource and an LCH or a flow.

It should be noted that the methods described in the following may be randomly combined with a technical solution in Embodiment 1 and/or Embodiment 2, which is not limited in this application. In other words, the methods described in the following may be applied to Embodiment 1 or may be applied to Embodiment 2.

As described above, the first information and/or the third information may be determined based on the second information. The following describes the second information in detail.

In some embodiments, the second information may include feature information of a target service, or data, or an LCH, or a PDU, or a flow, and/or, the second information may include change information of the feature information of the target service, the data, the LCH, the PDU, or the flow, and/or, a requested resource configuration, and/or, reported data volume information that is expected to be received by a peer end or a network device, and/or reported data volume information that is expected to arrive at a peer end or a network device. The target service, the data, the LCH, or the PDU may refer to a variable-rate service, variable-rate data, a variable-rate LCH, or a variable-rate PDU, or a multi-flow service, multi-flow data, a multi-flow LCH, or a multi-flow PDU. In at least one embodiment, the second information may further include feature information of a frame, a PDU set, a coding slice, or a packet, or change information of the feature information of the frame, the PDU set, the coding slice, or the packet.

In at least one embodiment, when the second information includes feature information of a target service, data, an LCH, a PDU, or a flow, the second information may include, for example, one or more of the following: data packet size information; data rate information; packet quantity information; frame rate information; PDU set information; multi-flow presence or indication information; feature information of each flow; information about the terminal device; or multi-flow feature information (for example, a multi-flow relationship) or the like. In an example, after receiving the second information, a network device may determine, based on the second information, whether to configure a first resource for the terminal device and information about multiple transmission resources configured in one period of the first resource. In another example, a network device may determine, based on the second information, whether to configure multiple second resources for the terminal device and information about one transmission resource configured in one period of a second resource. In another example, a network device may adjust a configuration of a first resource, a configuration of a second resource, or another RRC configuration parameter such as an LCH configuration parameter or a DRB configuration parameter, according to the second information.

It should be noted that data packet size information mentioned in this embodiment of this application may also be replaced with data volume information in some embodiments. The data packet size information and the data volume information is not distinguished from each other in this application. Data packet size information mentioned in the following may also be replaced with the data volume information.

In at least one embodiment, when the second information includes change information of feature information of a target service, or data, or an LCH, or a PDU, or a flow, the second information may only be used to indicate that the feature information of the target service, the data, the LCH, the PDU, or the changes, or may be specifically used to indicate an extent to which the feature information changes or the like. This is not specifically limited in this application. For example, the second information may include one or more of the following: a data packet changes or becomes larger and/or becomes smaller; a data packet size is greater than or equal to a first threshold and/or is less than a second threshold; change information or a rule of a data packet size; level information of a data packet size; a value of a data packet size; a data rate changes or becomes larger and/or becomes smaller; a data rate is greater than or equal to a third threshold and/or is less than a fourth threshold; change information or a rule of a data rate; level information of a data rate; a value of a data rate; a packet quantity changes or becomes larger and/or becomes smaller; a packet quantity is greater than or equal to a fifth threshold and/or is less than a sixth threshold; change information or a rule of a packet quantity; level information of a packet quantity; a value of a packet quantity; a frame rate changes or becomes larger and/or becomes smaller; a frame rate is greater than or equal to a seventh threshold and/or is less than an eighth threshold; change information or a rule of a frame rate; level information of a frame rate; a value of a frame rate size; a PDU set changes or becomes larger and/or becomes smaller; a PDU set is greater than or equal to a ninth threshold and/or is less than a tenth threshold; type change information of a PDU set; a type of a PDU set is a first type or a second type; a type of a PDU set changes; change information or a rule of a PDU set; level information of a PDU set; a size of a PDU in a PDU set; a quantity of PDUs in a PDU set; information about a data packet size within a period of time; information about a data rate within a period of time; information about a quantity of data packets within a period of time; packet quantity information within a period of time; frame rate information within a period of time; PDU set information within a period of time; multi-flow presence or indication information within a period of time; feature information of each flow within a period of time; multi-flow feature information within a period of time; change information or a rule of multi-flow presence or indication; change information or a rule of each flow feature; change information or a rule of a multi-flow feature; information about a quantity of data packets within different periods of time; information about a data packet size within different periods of time; a data or PDU size within a transmission pattern; an amount of data or a quantity of PDUs within a transmission pattern; a change of a data or PDU size within a transmission pattern; a change of an amount of data or a quantity of PDUs within a transmission pattern; a change of a period of a transmission pattern; or a period of a transmission pattern.

In at least one embodiment, a period of time may refer to a corresponding time for indicating information, for example, may include one or more of a start time instant, an end time instant, or duration (duration, or referred to as a time length). In at least one embodiment, a first-type PDU set may be an I frame, or may be a PDU set corresponding to an I frame. A second-type PDU set may be a P or B frame, or may be a PDU set corresponding to a P or B frame. In at least one embodiment, a packet (packet) may also be referred to as a data packet. The packet may refer to a packet of an application layer, or may refer to a packet of an air interface. In at least one embodiment, a flow may refer to a data flow. Alternatively, a flow may also refer to a QoS flow.

The second information may be one or more types of granularity information, which is not limited in this application. For example, the second information may include one or more of the following granularity information: information about a PDU session granularity; information about a quality of service QoS flow granularity; information about a service granularity; information about a system frame granularity; information about a PDU set granularity; information about a packet granularity; information about a data radio bearer DRB granularity; information about an LCH granularity; information about a flow granularity; information about the terminal device; or information about a CG or SPS resource granularity.

In some embodiments, the second information may be used to indicate that a first object exists, and related information of the first object is changeable. The first object may include one or more of the following: a PDU session, a QoS flow, a service, a system frame, a PDU set, a packet, a DRB, an LCH, the terminal device, a flow, or a CG or SPS resource. The related information of the first object may include one or more of the following: data packet size information; data rate information; packet quantity information; frame rate information; PDU set information; multi-flow presence or indication information; feature information of each flow; information about the terminal device; or multi-flow feature information. In at least one embodiment, the related information of the first object is used to indicate that a data packet size or a data rate of the first object changes. For example, the related information of the first object may also be the second information described above. In some embodiments, the related information of the first object may be further used to indicate that a data packet of the first object is relatively large.

In some embodiments, a resource configuration of a first resource or a second resource is changeable. It should be noted that, the resource configuration mentioned in this embodiment of this application may also be replaced with resource scheduling or a resource indication in some embodiments. The resource configuration, the resource scheduling and the resource indication are not distinguished from each other in this application. The resource configuration mentioned in the following may also be replaced with the resource scheduling or the resource indication. With reference to FIG. 5, the following describes the resource configuration of the first resource or the second resource.

FIG. 5 is a schematic flowchart of a communication method according to yet another embodiment of this application. As shown in FIG. 5, the communication method may include step S510 and step S520.

In step S510, a terminal device receives third indication information. The third indication information is used to instruct to change a resource configuration of a first resource or a second resource.

In some embodiments, the third indication information may be transmitted by a network device. For example, the network device may transmit the third indication information to the terminal device by using RRC, DCI, or a MAC control element (control element, CE).

Specific content of the resource configuration is not limited in embodiments of this application. For example, the resource configuration may include at least one of the following: a period, a resource offset, a resource size, a resource quantity, a time domain position, a frequency domain position, a quantity of times of repetition, a quantity of PUSCHs or PDSCHs in each time unit, or a quantity of time units in one period. In at least one embodiment, when the first resource is a CG resource and a DG resource, the resource configuration may further include related information of at least one DG resource. It should be understood that, a meaning of the resource configuration in the requested resource configuration described above may be the same as a meaning of the resource configuration herein. It should be understood that a resource offset may refer to an offset of the first resource, or may refer to an offset of the second resource. In some embodiments, the resource offset may refer to a resource offset in one period, or may refer to a resource offset in a total quantity of configured resources, for example, a resource offset in multiple configured first resources or multiple configured second resources. A resource size, a resource quantity, a time domain position, a frequency domain position, or a quantity of times of repetition may refer to a resource size, a resource quantity, a time domain position, a frequency domain position, or a quantity of times of repetition that is in one period, or may refer to a resource size, a resource quantity, a time domain position, a frequency domain position, or a quantity of times of repetition that is in a total quantity of configured resources. Details are not described herein again. This embodiment of this application does not limit a time unit. For example, the time unit may be, for example, a slot, a symbol, or a millisecond, or the time unit may be, for example, a period of the first resource or that of the second resource. In at least one embodiment, information corresponding to the time unit may be an integer or a non-integer, and may be a positive number or a negative number.

In some embodiments, changing the resource configuration of the first resource or the second resource include changing one or more of duration, a start time instant, or an end time instant of the resource configuration. For example, the third indication information may be used to indicate the duration of changing the resource configuration, or may be used to indicate changing both the start time instant and the end time instant of the resource configuration. In at least one embodiment, when changing the resource configuration includes multiple items (for example, changing both the start time instant and the end time instant of the resource configuration), indication information used to indicate the change may be carried in same signalling, or may be carried in different signalling.

This embodiment of this application does not limit a manner of indicating a specific value of the duration, the start time instant, or the end time instant of the resource configuration. For example, the value may be indicated by network indication information. Alternatively, the value may be pre-defined or pre-configured in a protocol. Alternatively, the value may be indicated by a bitmap, and multiple indicator bits in the bitmap correspond to multiple values of resource configuration.

In step S520, the terminal device changes the resource configuration of the first resource or the second resource according to the third indication information.

In some embodiments, when a change of the resource configuration becomes invalid (for example, the duration of the resource configuration expires, or times out, or arrives, or exceeds the end time instant of the resource configuration), the terminal device may use a configuration before the change. In some embodiments, when a change of the resource configuration becomes invalid, the terminal device may use a default resource configuration (for example, a previously configured resource configuration). In a specific example, a period corresponding to a first resource configured for a current terminal device is 10 ms. At a time instant a, the terminal device receives indication information, where the indication information is used to instruct the terminal device to change the period corresponding to the first resource to 20 ms, and an end time instant is a time instant b. After the terminal device changes the period according to the indication information and the change takes effect, a period corresponding to the first resource is 20 ms before the time instant b. If the change becomes invalid at the time instant b, the terminal device may use the configuration (10 ms) before the change, or the terminal device may use the default resource configuration (for example, 5 ms).

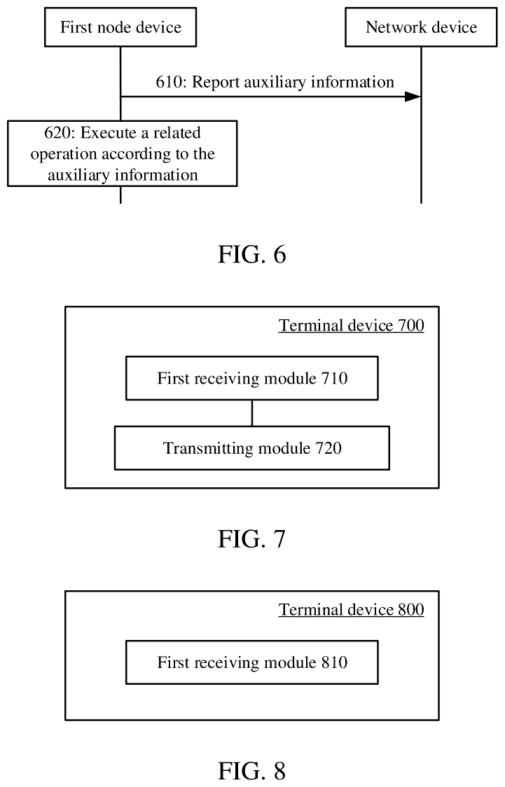

In some embodiments, a network device may determine, based on auxiliary information, whether to configure the first resource or the second resource, or adjust a configuration of the first resource or the second resource according to the auxiliary information. The following provides detailed descriptions with reference to FIG. 6.

FIG. 6 is a schematic flowchart of a communication method according to still yet another embodiment of this application. As shown in FIG. 6, the communication method may include step S610 and step S620.

In step S610, a first node device reports auxiliary information. The auxiliary information is used to indicate feature information of a target service, data, an LCH, a PDU, or a flow; or is used to indicate change information of the feature information of the target service, the data, the LCH, the PDU, or the flow; or is used to indicate changed request information; or is used to indicate that the feature information of the target service, the data, the LCH, the PDU, or the flow changes; or is used to indicate a level of a change of the feature information of the target service, the data, the LCH, the PDU, or the flow; or is used to indicate a rule of the feature information of the target service, the data, the LCH, the PDU, or the flow; or is used to indicate a requested resource configuration, or report data volume information that is expected to be received by a peer end or a network device, or report data volume information that is expected to arrive at a peer end or a network device.

In some embodiments, the auxiliary information may be the second information described above. In some embodiments, the auxiliary information may also be one or more types of granularity information, which is not limited in this application. For example, the auxiliary information may include one or more of the following granularity information: information about a PDU session granularity; information about a quality of service QoS flow granularity; information about a service granularity; information about a system frame granularity; information about a PDU set granularity; information about a packet granularity; information about a data radio bearer DRB granularity; information about an LCH granularity; information about a flow granularity; information about the terminal device; or information about a CG or SPS resource granularity.

In some embodiments, the auxiliary information may also be used to indicate that a first object exists, and related information of the first object is changeable. The first object may include one or more of the following: a PDU session, a QoS flow, a service, a system frame, a PDU set, a packet, a DRB, an LCH, the terminal device, a flow, or a CG or SPS resource. The related information of the first object may include one or more of the following: data packet size information; data rate information; packet quantity information; frame rate information; PDU set information; multi-flow presence or indication information; feature information of each flow; information about a terminal device; or multi-flow feature information. In at least one embodiment, the related information of the first object is used to indicate that a data packet size or a data rate of the first object changes. For example, the related information of the first object may also be second information or auxiliary information. In some embodiments, the related information of the first object may be further used to indicate that a data packet of the first object is relatively large.

In some embodiments, a first resource or a second resource may be associated with the first object, for example, associated with a PDU session, a QoS flow, a service, a DRB, or an LCH. In other words, only a corresponding PDU session, a corresponding QoS flow, a corresponding service, a corresponding DRB, or a corresponding LCH may be transmitted on an associated first resource or an associated second resource, or a corresponding PDU session, a corresponding QoS flow, a corresponding service, a corresponding DRB, or a corresponding LCH may be preferentially transmitted on an associated first resource or an associated second resource.

In some embodiments, a network device may further indicate or configure an association between a target service, or an LCH, or an LCG, or an LCH set and a resource, for example, a relationship with dynamic scheduling, a CG or an SPS, or an RRC configuration parameter. In this case, the resource may be used to transmit only or preferentially transmit the associated service, the associated LCH, the associated LCG, or the associated LCH set.

In some embodiments, the auxiliary information may further include fourth information, and the fourth information is used to indicate one or more of duration, a start time instant, or an end time instant of the requested resource configuration.

In some embodiments, the first node device may transmit the auxiliary information to a network device by using RRC or a MAC CE or UJEAssistance Information or UCI.

In some embodiments, the auxiliary information is triggered when a first condition is met, or transmission of the auxiliary information is triggered when a first condition is met, and the first condition includes at least one of the following: initial reporting; reaching a trigger period; exceeding trigger prohibition duration; variable-rate or multi-flow data or a variable-rate or multi-flow service or a variable-rate or multi-flow LCH exists; a data packet size or a data volume changes; information about a data packet size changes; a data packet changes or becomes larger and/or becomes smaller; a data packet size is greater than or equal to a first threshold, and/or is less than a second threshold; information about a data rate changes; a data rate changes or becomes larger and/or becomes smaller; a data rate is greater than or equal to a third threshold and/or is less than a fourth threshold; information about a packet quantity changes; a packet quantity changes or becomes larger and/or becomes smaller; a packet quantity is greater than or equal to a fifth threshold and/or is less than a sixth threshold; information about a frame rate changes; a frame rate changes or becomes larger and/or becomes smaller; a frame rate is greater than or equal to a seventh threshold and/or is less than an eighth threshold; information about a PDU set changes; a PDU set changes or becomes larger and/or becomes smaller; a PDU set is greater than or equal to a ninth threshold and/or is less than a tenth threshold; type change information of a PDU set; a type of a PDU set is a first type or a second type; change information of multi-flow presence or indication; change information of each flow feature; a change of a data packet size within a period of time; a change of a data rate within a period of time; a change of a packet quantity within a period of time; a change of frame rate information within a period of time; a change of PDU set information within a period of time; a change of multi-flow presence or indication information within a period of time; a change of feature information of each flow within a period of time; a change of multi-flow feature information within a period of time; a change of a data or PDU size within a transmission pattern; a change of an amount of data or a quantity of PDUs within a transmission pattern; or a change of a period of a transmission pattern.

This embodiment in this application does not limit a manner of triggering, reporting, or transmitting the auxiliary information. For example, the triggering of the auxiliary information, or the reporting of the auxiliary information, or the transmission of the auxiliary information may be periodic or aperiodic, and may be performed in response to a condition or an event.

In some embodiments, the reporting of the auxiliary information or the triggering of the auxiliary information is performed for one object, or is performed for multiple objects, and the object includes at least one of the following: a PDU session, a QoS flow, a service, a system frame, a PDU set, a packet, a DRB, an LCH, a flow, a terminal device, a radio link control protocol RLC, a logical channel group LCG, an LCH set, a MAC entity, a carrier, a CG index (index), a CG group index, an SPS index, or an SPS group index. In at least one embodiment, when the reporting or triggering of the auxiliary information is performed for one object, the object may carry, for example, an object identifier. In at least one embodiment, when the reporting or triggering of the auxiliary information is performed for multiple objects, the multiple objects may carry, for example, multiple object identifiers, or may carry no object identifiers. In a case in which the multiple objects carry no object identifiers, for example, a correspondence between each reported object and the auxiliary information may be determined based on a default order of the objects, or each position may correspond to one object according to a bitmap (bitmap) position.

In an example, the reporting of the auxiliary information is performed for one object (which, for example, carries an object identifier) or multiple objects (which, for example, may carry or may not carry identifiers of the multiple objects (In at least one embodiment, each reported object is determined based on a default order of the objects, or each position corresponds to one object according to a bitmap position)). The object includes at least one of the following: a PDU session, a QoS flow, a service, a system frame, a PDU set, a packet, a DRB, an LCH, a flow, a UE, an RLC, an LCG, an LCH set, a MAC entity, a carrier, a CG index, a CG group index, an SPS index, or an SPS group index.

In another example, the triggering of the auxiliary information is performed for one object (which, for example, carries an object identifier) or multiple objects (which, for example, may carry or may not carry identifiers of the multiple objects (In at least one embodiment, each reported object is determined based on a default order of the objects, or each position corresponds to one object according to a bitmap position)). The object includes at least one of the following: a PDU session, a QoS flow, a service, a system frame, a PDU set, a packet, a DRB, an LCH, a flow, a UE, an RLC, an LCG, an LCH set, a MAC entity, a carrier, a CG index, a CG group index, an SPS index, or an SPS group index.

In at least one embodiment, when the auxiliary information is triggered or reported for an object by using a MAC CE, the object includes at least one of the following: a DRB, an RLC, an LCH, an LCG, an LCH set, a MAC entity, or a carrier. For example, the MAC CE may be an existing MAC CE or a new MAC CE. The existing MAC CE may be, for example, a BSR MAC CE.

In at least one embodiment, when the auxiliary information is triggered or reported for an object by using UCI, the object includes at least one of the following: a DRB, an RLC, an LCH, a CG index, a CG group index, an SPS index, an SPS group index, a MAC entity, or a carrier. For example, the UCI may be an existing SR (for example, different SR indexes or different configurations of SR indexes are related to different auxiliary information) or include at least CG-UCI in the auxiliary information.

In some embodiments, a network device (for example, a base station) executes, by using the auxiliary information, at least one of the following actions: executing scheduling or resource allocation; executing RRC parameter configuration or adjustment; adjusting a manner of scheduling a first resource; adjusting resource allocation of a first resource; or scheduling an unused transmission resource in multiple transmission resources for use by another terminal device.

A specific manner of triggering or reporting auxiliary information by using a MAC CE is not limited in embodiments of this application. The following provides several examples.

Manner 1: a corresponding XR service, or a corresponding XR LCH, or a corresponding multi-flow or variable-rate service, or a corresponding multi-flow or variable-rate LCH is limited by using an existing BSR MAC CE, and is mapped to a same LCG or a same LCH set. In at least one embodiment, a table with a new buffer size level (buffer size levels) (for example, in bytes (in bytes)) is added, for example, a buffer size range or a data volume range corresponding to each index indicator bit is increased, to adapt to the service. In at least one embodiment, when a first condition is met, BSR reporting is triggered, or a BSR MAC CE is generated. In at least one embodiment, an LCID identifier corresponding to a new MAC CE is used. In at least one embodiment, when a first condition is met, BSR reporting at this level is triggered, or a BSR MAC CE at this level is generated. In at least one embodiment, a logical channel priority of this MAC CE is higher than or equal to that of an existing BSR MAC CE (for example, a conventional BSR MAC CE).

If a new LCID is used to associate with this MAC CE, at least one of the following is included.

In at least one embodiment, this BSR or this BSR reporting is triggered and is not canceled, and a UL-SCH resource used for new transmission may carry this BSR MAC CE and a sub-header of the BSR MAC CE, to instruct the multiplexing and assembly procedure (the Multiplexing and Assembly procedure) to generate this BSR MAC CE. Otherwise, an SR is triggered.

In at least one embodiment, one MAC PDU may report one or more such BSR MAC CEs, or one MAC PDU may report a maximum of one such BSR MAC CE (even if multiple events trigger this BSR). It should be understood that this BSR MAC CE may be generated by instructing the multiplexing and assembly procedure in a case in which an existing BSR or existing BSR reporting associated with a new LCID is triggered and is not canceled.

In at least one embodiment, one MAC PDU may report a maximum of one such BSR MAC CE and an existing BSR MAC CE (for example, one of a conventional BSR MAC CE, a periodic BSR MAC CE, and a padding BSR MAC CE).

In at least one embodiment, in a case in which one MAC PDU includes a MAC CE of this BSR (further, this MAC PDU is transmitted), all such BSRs that are triggered will be canceled (cancel).

In at least one embodiment, this BSR MAC CE is a MAC CE with a fixed size.

In at least one embodiment, this BSR MAC CE is identified by using an LCID corresponding to a MAC sub-packet header of this BSR MAC CE.

Manner 2: An existing BSR MAC CE is enhanced, which includes at least one of the following: a corresponding XR service, or a corresponding XR LCH, or a corresponding multi-flow or variable-rate service, or a corresponding multi-flow or variable-rate LCH is limited to be mapped to a same LCG or a same LCH set, or a quantity of existing LCGs or existing LCH sets is changed from 4 to a quantity of variable LCGs or variable LCH sets for reporting (a value ranging from 1 to X may be reported, where X is greater than 4). Correspondingly, a size or payload (payload) of a MAC CE is variable. Correspondingly, an LCID corresponding to a new MAC CE is used. In at least one embodiment, a table with a new buffer size level (for example, in bytes) is added, for example, a buffer size range or a data volume range corresponding to each index indicator bit is increased, to adapt to the service. In at least one embodiment, when a first condition is met, this BSR reporting is triggered, or this BSR MAC CE is generated. In at least one embodiment, a logical channel priority of this MAC CE is higher than or equal to that of an existing BSR MAC CE (for example, a conventional BSR MAC CE).

In at least one embodiment, this BSR or this BSR reporting is triggered and is not canceled, and a UL-SCH resource used for new transmission may carry this BSR MAC CE and a sub-header of the BSR MAC CE, to instruct the multiplexing and assembly procedure to generate this BSR MAC CE. Otherwise, an SR is triggered.

In at least one embodiment, one MAC PDU may report one or more such BSR MAC CEs, or one MAC PDU may report a maximum of one such BSR MAC CE (even if multiple events trigger this BSR). It should be understood that this BSR MAC CE may be generated by instructing the multiplexing and assembly procedure in a case in which an existing BSR or existing BSR reporting associated with a new LCID is triggered and is not canceled.

In at least one embodiment, one MAC PDU may report a maximum of one such BSR MAC CE and an existing BSR MAC CE (for example, one of a conventional BSR MAC CE, a periodic BSR MAC CE, and a padding BSR MAC CE).

In at least one embodiment, in a case in which one MAC PDU includes a MAC CE of this BSR (further, this MAC PDU is transmitted), all such BSRs that are triggered will be canceled.

In at least one embodiment, this BSR MAC CE is a MAC CE with a variable size or a MAC CE with a fixed size.

In at least one embodiment, this BSR MAC CE is identified by using an LCID corresponding to a MAC sub-packet header of this BSR MAC CE.

Manner 3: An existing BSR MAC CE format is enhanced, and a reserved R bit is used to indicate that information changes, or information becomes larger, or information becomes smaller. Correspondingly, an LCID corresponding to a new MAC CE is used. In at least one embodiment, a table with a new buffer size level (for example, in bytes) is added, for example, a buffer size range or a data volume range corresponding to each index indicator bit is increased, to adapt to the service. In at least one embodiment, when a first condition is met, this BSR reporting is triggered, or this BSR MAC CE is generated. In at least one embodiment, a logical channel priority of this MAC CE is higher than or equal to that of an existing BSR MAC CE (for example, a conventional BSR MAC CE).

In at least one embodiment, this BSR or this BSR reporting is triggered and is not canceled, and a UL-SCH resource used for new transmission may carry this BSR MAC CE and a sub-header of the BSR MAC CE, to instruct the multiplexing and assembly procedure to generate this BSR MAC CE. Otherwise, an SR is triggered.

In at least one embodiment, one MAC PDU may report one or more such BSR MAC CEs, or one MAC PDU may report a maximum of one such BSR MAC CE (even if multiple events trigger this BSR). It should be understood that this BSR MAC CE may be generated by instructing the multiplexing and assembly procedure in a case in which an existing BSR or existing BSR reporting associated with a new LCID is triggered and is not canceled.

In at least one embodiment, one MAC PDU may report a maximum of one such BSR MAC CE and an existing BSR MAC CE (for example, one of a conventional BSR MAC CE, a periodic BSR MAC CE, and a padding BSR MAC CE).

In at least one embodiment, in a case in which one MAC PDU includes a MAC CE of this BSR (further, this MAC PDU is transmitted), all such BSRs that are triggered will be canceled. In at least one embodiment, this BSR MAC CE is a MAC CE with a variable size or a MAC CE with a fixed size.

In at least one embodiment, this BSR MAC CE is identified by using an LCID corresponding to a MAC sub-packet header of this BSR MAC CE.

Manner 4: A new MAC CE or a new BSR is introduced, and a corresponding logical channel ID is introduced. The MAC CE or the BSR is used to report at least one of content of auxiliary information, for example, report data information that is expected to arrive at a network device. A BSR MAC CE is identified by using an LCID corresponding to a MAC sub-packet header of this BSR MAC CE.

In at least one embodiment, when a first condition is met, a new MAC CE or new BSR reporting is triggered, or a corresponding MAC CE is generated. In at least one embodiment, a logical channel priority of this MAC CE is higher than or equal to that of an existing BSR MAC CE (for example, a conventional BSR MAC CE).

For example, configuration of a new MAC CE or new BSR reporting may include: if a new MAC CE is configured to trigger or report auxiliary information, the new MAC CE or a new BSR performs triggering or reporting in some cases, for example, performs triggering or reporting in a case in which a first condition is met. If a new MAC CE is configured to trigger or report auxiliary information, the new MAC CE or a new BSR performs triggering or reporting for a first object.

In at least one embodiment, a new BSR or new BSR reporting is triggered and is not canceled, and a UL-SCH resource used for new transmission may carry this BSR MAC CE and a sub-header of the BSR MAC CE, to instruct the multiplexing and assembly procedure (the Multiplexing and Assembly procedure) to generate this BSR MAC CE. Otherwise, an SR is triggered.

In at least one embodiment, one MAC PDU may report one or more such BSR MAC CEs, or one MAC PDU may report a maximum of one such BSR MAC CE (even if multiple events trigger this BSR). It should be understood that this BSR MAC CE may be generated by instructing the multiplexing and assembly procedure in a case in which a new BSR or new BSR reporting is triggered and is not canceled.

In at least one embodiment, one MAC PDU may report a maximum of one such BSR MAC CE and an existing BSR MAC CE (for example, one of a conventional BSR MAC CE, a periodic BSR MAC CE, and a padding BSR MAC CE).

In at least one embodiment, in a case in which one MAC PDU includes a MAC CE of this BSR (further, this MAC PDU is transmitted), all such BSRs that are triggered will be canceled (cancel).

In at least one embodiment, this BSR MAC CE is a MAC CE with a variable size or a MAC CE with a fixed size.

In at least one embodiment, this BSR MAC CE is identified by using an LCID corresponding to a MAC sub-packet header of this BSR MAC CE.

In at least one embodiment, a logical channel priority of this BSR MAC CE is higher than or equal to that of an existing BSR MAC CE (for example, one of a conventional BSR MAC CE, a periodic BSR MAC CE, or a padding BSR MAC CE).

It should be understood that the BSR may be replaced with another term, for example, the variable-rate status report, which is not limited in embodiments of this application.

A specific type of the first node device is not limited in embodiments of this application, provided that the first node device can report auxiliary information to a network device. For example, the first node device may include one or more of the following devices: a terminal device, a core network element (such as a UPF network element or an SMF network element), a server, or a central control node.

In step S620, a network device executes, according to the auxiliary information, one or more of the following operations: adjusting a manner of scheduling a first resource; or adjusting resource allocation of a first resource; or adjusting a configuration of a second resource; or scheduling an unused transmission resource in multiple transmission resources for use by another terminal device; or configuring an RRC parameter; or adjusting an RRC parameter; or scheduling an unused second resource in multiple second resources for use by another terminal device.

In some embodiments, adjusting a manner of scheduling a first resource by a network device according to the auxiliary information may include: executing, by the network device, dynamic scheduling according to reported latest auxiliary information; or executing, by the network device, RRC parameter configuration according to reported latest auxiliary information.

In some embodiments, adjusting a manner of allocating a first resource by a network device according to the auxiliary information may include: adjusting, by the network device, a pre-configured first resource (for example, a CG resource or an SPS resource) according to reported latest auxiliary information, specifically, for example, adjusting a resource configuration (a period, a resource size, a resource quantity, or the like) of the pre-configured first resource; or activating or deactivating, by the network device, a first resource (for example, a CG resource or an SPS resource) according to reported latest auxiliary information.

In some embodiments, a network device adjusts a configuration or scheduling according to the auxiliary information, where the auxiliary information is a requested configuration. A network may configure final configuration information or scheduling, or may indicate confirmed indication information for the requested configuration.

In some embodiments, adjusting, by a network device, an unused transmission resource in multiple transmission resources for use by another terminal device according to the auxiliary information may include: scheduling, by the network device according to reported latest auxiliary information, an unused TB resource in the multiple transmission resources or an unused TB resource in multiple TB resources existing in one transmission resource for use by another terminal device.

In embodiments of this application, auxiliary information can be obtained, so that the network device can adjust scheduling and a resource configuration according to the obtained auxiliary information, thereby further reducing resource waste while ensuring service transmission.

In some embodiments, the network device may determine information about an unused transmission resource in multiple transmission resources or information about an unused second resource in multiple second resources, to schedule the unused transmission resource or the unused second resource for use by another terminal device. A manner in which the network device determines an unused transmission resource or an unused second resource is not limited in embodiments of this application. For example, a terminal device may report, to the network device, information about an unused transmission resource in multiple transmission resources configured in one period or information about an unused second resource in multiple second resources. Alternatively, the network device may determine, based on the auxiliary information reported by the first node device or based on second information, information about an unused transmission resource in multiple transmission resources configured in one period or information about an unused second resource in multiple second resources.

In some embodiments, a terminal device may further receive fourth indication information, where the fourth indication information is used to instruct to activate one or more functions of the terminal device. For example, the fourth indication information may be used to instruct to activate at least one of the following functions of the terminal device: a function of reporting auxiliary information; a function of determining a HARQ process ID; or a function of reporting a HARQ process ID or the like.

The following describes the technical solutions of this application with reference to several specific examples.

### Example 1

A solution in Example 1 is applicable to determining a HARQ process ID available to a CG PUSCH in a case in which more than one CG PUSCH exists in one CG period. Specifically, an implementation procedure may include the following step 1 and step 2.

In step 1, a network configures a CG resource and a HARQ process corresponding to the CG resource.

In some embodiments, the network configures multiple HARQ process IDs in a case in which more than one CG PUSCH or more than one CG transmission resource is included in one period of a CG resource.

In at least one embodiment, the network configures a HARQ process ID set available to the CG resource, for example, configures a quantity and a relative offset. In at least one embodiment, an existing HARQ process ID or a quantity of existing HARQ process IDs may be extended. In at least one embodiment, the network configures HARQ process IDs available to different CG PUSCHs in one CG period.

The network may configure, in different manners, HARQ process IDs available to different CG PUSCHs in one CG period. In at least one embodiment, a HARQ process ID available to the first or the A^{th} CG PUSCH or the first or the A^{th} CG transmission resource is configured by using an RRC configuration, for example, CG config. In addition, an offset of another CG PUSCH or another CG transmission resource relative to the HARQ process ID of the first or the A^{th} CG PUSCH or the first or the A^{th} CG transmission resource is configured. In at least one embodiment, a HARQ process ID available to the first or the A^{th} CG PUSCH or the first or the A^{th} CG transmission resource is configured by using an RRC configuration, for example, CG config, and an offset of another CG PUSCH or another CG transmission resources relative to the HARQ process ID of the first or the A^{th} CG PUSCH or the first or the A^{th} CG transmission resource is indicated by DCI. In at least one embodiment, a HARQ process ID available to the first or the A^{th} CG PUSCH or the first or the A^{th} CG transmission resource is configured by using an RRC configuration, for example, CG config, and a set of offsets of other CG PUSCHs or other CG transmission resources relative to the HARQ process ID of the first or the A^{th} CG PUSCH or the first or the A^{th} CG transmission resource is indicated by DCI. In at least one embodiment, a HARQ process ID available to each CG PUSCH or each CG transmission resource is configured by using an RRC or DCI configuration, for example, CG config.

In step 2, a terminal device receives the CG resource and a HARQ configuration or indication that are configured by the network, determines a HARQ process, and performs transmission.

In at least one embodiment, in one CG period, HARQ process IDs used by different CG PUSCHs are different. Specifically, one of the following manners 1 to 3 may be used.

Manner 1: HARQ process IDs used by all CG PUSCHs in each CG period are determined based on an implementation of the terminal device. In the manner 1, the terminal device may indicate, by using, for example, CG UCI, a HARQ process ID used by the network.

Manner 2: A HARQ process ID used by the first or the A^{th} CG PUSCH in one CG period is determined based on a first factor or a first formula, and a HARQ process ID used by another CG PUSCH in the one CG period is determined by using the terminal device. In the manner 2, the terminal device may indicate, by using, for example, CG UCI, a HARQ process ID used by the network.

Manner 3: A HARQ process ID used by a CG PUSCH in one CG period is determined based on a first factor or a first formula, and a second factor or a second formula.

In at least one embodiment, the first factor may include at least one of the following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of LCHs. The second factor may include at least one of the following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, an offset of the another transmission resource relative to the first transmission resource, a quantity of flows, or a quantity of LCHs.

In at least one embodiment, in each CG index, when quantities of PUSCHs in all periods are the same, the first formula and the second formula may be one or more of the following for different cases.

Case 1: for example, neither harq-ProcID-Offset2 nor cg-RetransmissionTimer is configured for an uplink CG (For configured uplink grants neither configured with harq-ProcII)-Offset2 nor with cg-RetransmissionTimer). The first formula may be: HARQ process ID of the first or the A^{th} CG PUSCH=M*{[floor (CURRENT_symbol/periodicity)] modulo nrofHARQ-Processes}, where M is a quantity of CG PUSCHs in one CG period, or a quantity of different HARQ process IDs that are to be used in one CG period, and HARQ process IDs used by a same repetition are the same. The second formula may be: HARQ process ID of another CG PUSCH=M*{[floor (CURRENT_symbol/periodicity)] modulo nrofHARQ-Processes}+offset N, where M is a quantity of CG PUSCHs in one CG period, or a quantity of different HARQ process IDs that are to be used in one CG period, and offset N is an offset of the configured or indicated CG PUSCH relative to the A^{th} CG PUSCH, and HARQ process IDs used by a same repetition are the same.

Case 2: for example, harq-ProcID-Offset2 is configured for an uplink CG (For configured uplink grants with harq-ProcID)-Offset2), the first formula may be: HARQ process ID of the first or the A^{th} CG PUSCH=M*{[floor (CURRENT_symbol/periodicity)] modulo nrofHARQ-Processes+harq-ProcID-Offset2}, where M is a quantity of CG PUSCHs in one CG period, or a quantity of different HARQ process IDs that are to be used in one CG period, and HARQ process IDs used by a same repetition are the same. The second formula may be: HARQ process ID of another CG PUSCH=M*{[floor (CURRENT_symbol/periodicity)] modulo nrofHARQ-Processes+harq-ProcID-Offset2}+offset N, where M is a quantity of CG PUSCHs in one CG period, or a quantity of different HARQ process IDs that are to be used in one CG period, offset N is an offset of the configured or indicated CG PUSCH relative to the A^{th} CG PUSCH, and HARQ process IDs used by a same repetition are the same.

In at least one embodiment, Example 1 may further include step 3. In step 3, the network determines, based on first information, that some CG positions are not used, and may be used by another terminal device.

It should be noted that the solution in Example 1 may also be applicable to a case of dynamic scheduling (for example, multiple PUSCHs are scheduled, but a HARQ process of each PUSCH is not indicated, and HARQ processes of at least one PUSCH are different). In at least one embodiment, the solution in Example 1 may also be used to indicate, to the network, how the terminal device determines a HARQ process when multiple dynamically scheduled grants are provided for use by the terminal device. For example, a HARQ process at the first position is indicated in DCI, and a HARQ process at another position is determined based on an offset indicated by RRC or DCI. Alternatively, DCI indicates a HARQ process ID of each position.

In at least one embodiment, an RV used by each resource may be indicated by using a solution similar to the solution in Example 1.

By using the solution in Example 1, when multiple CG PUSCHs exist in one CG period, a HARQ process ID can be determined to ensure service transmission.

### Example 2

A solution in Example 2 is applicable to determining a HARQ process ID available to an SPS PDSCH in a case in which more than one SPS PDSCH exists in one SPS period. A specific implementation procedure may include the following step 1 and step 2.

In step 1, a network configures an SPS resource and a HARQ process corresponding to the SPS resource.

In some embodiments, the network configures multiple HARQ process IDs in a case in which more than one SPS PDSCH or more than one SPS transmission resource is included in one period of an SPS resource.

In at least one embodiment, the network configures a HARQ process ID set available to the SPS resource, for example, configures a quantity and a relative offset. In at least one embodiment, an existing HARQ process ID or a quantity of existing HARQ process IDs may be extended. In at least one embodiment, the network configures HARQ process IDs available to different SPS PDSCHs in one SPS period.

The network may configure, in different manners, HARQ process IDs available to different SPS PDSCHs in one SPS period. In at least one embodiment, a HARQ process ID available to the first or the A^{th} SPS PDSCH or the first or the A^{th} SPS transmission resource is configured by using an RRC configuration, for example, SPS config. In addition, an offset of another SPS PDSCH or another SPS transmission resource relative to the HARQ process ID of the first or the A^{th} SPS PDSCH or the first or the A^{th} SPS transmission resource is configured. In at least one embodiment, a HARQ process ID available to the first or the A^{th} SPS PDSCH or the first or the A^{th} SPS transmission resource is configured by using an RRC configuration, for example, SPS config. An offset of another SPS PDSCH or another SPS transmission resource relative to the HARQ process ID of the first or the A^{th} SPS PDSCH or the first or the A^{th} SPS transmission resource is indicated by DCI. In at least one embodiment, a HARQ process ID available to each SPS PDSCH or each SPS transmission resource is configured by using an RRC or DCI configuration, for example, SPS config.

In step 2, a terminal device receives the SPS resource and a HARQ configuration or indication that are configured by the network, determines a HARQ process, and performs transmission.

In at least one embodiment, in one SPS period, HARQ process IDs used by different SPS PDSCHs are different. Specifically, a HARQ process ID used by an SPS PDSCH in one SPS period is determined based on a first factor or a first formula, and a second factor or a second formula.

In at least one embodiment, the first factor may include at least one of the following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of LCHs. The second factor may include at least one of the following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, an offset of the another transmission resource relative to the first transmission resource, a quantity of flows, or a quantity of LCHs.

In at least one embodiment, in each SPS index, when quantities of PDSCHs in all periods are the same, the first formula and the second formula may be one or more of the following for different cases.

Case 1: for example, harq-ProcID)-Offset is not configured for a downlink grant (For configured downlink assignments without harq-ProcID)-Offset), the first formula may be: HARQ process ID of the first or the A^{th} SPS PDSCH=M*{[floor (CURRENT_slot×10/(numberOfSlotsPerFrame×periodicity))] modulo nrofHARQ-Processes}, where M is a quantity of SPS PDSCHs in one SPS period, or a quantity of different HARQ process IDs that are to be used in one SPS period, and HARQ process IDs used by a same repetition are the same. The second formula may be: HARQ process ID of another SPS PDSCH=M*{[floor (CURRENT_slot×10/(numberOfSlotsPerFrame×periodicity))] modulo nrofHARQ-Processes}+offset N, where M is a quantity of SPS PDSCHs in one SPS period, or a quantity of different HARQ process IDs that are to be used in one SPS period, offset N is an offset of the configured or indicated SPS PDSCH relative to the A^{th} SPS PDSCH, and HARQ process IDs used by a same repetition are the same.

Case 2: for example, harq-ProcID-Offset is configured for a downlink grant (For configured downlink assignments with harq-ProcID)-Offset), the first formula may be: HARQ process ID of the first or the A^{th} SPS PDSCH=M*{[floor (CURRENT_slot×10/(numberOfSlotsPerFrame×periodicity))] modulo nrofHARQ-Processes+harq-ProclD)-Offset}, where M is a quantity of SPS PDSCHs in one SPS period, or a quantity of different HARQ process IDs that are to be used in one SPS period, and HARQ process IDs used by a same repetition are the same. The second formula may be: HARQ process ID of another SPS PDSCH=M*{[floor (CURRENT_slot×10/(numberOfSlotsPerFrame×periodicity))] modulo nrofHARQ-Processes+harq-ProcID)-Offset}+offset N, where M is a quantity of SPS PDSCHs in one SPS period, or a quantity of different HARQ process IDs that are to be used in one SPS period, offset N is an offset of the configured or indicated SPS PDSCH relative to the A^{th} SPS PDSCH, and HARQ process IDs used by a same repetition are the same.

In at least one embodiment, Example 2 may further include step 3. In step 3, the network determines, based on first information, that some SPS positions are not used, and may be used by another terminal device.

It should be noted that the solution in Example 2 may also be applicable to a case of dynamic scheduling (for example, multiple PDSCHs are scheduled, but a HARQ process of each PDSCH is not indicated, and HARQ processes of at least one PDSCH are different). In at least one embodiment, the method in Example 2 may also be used to indicate, to the network, how the terminal device determines a HARQ process when multiple dynamically scheduled grants are provided for the terminal device for use. For example, a HARQ process at the first position is indicated in DCI, and a HARQ process at another position is determined based on an offset indicated by RRC or DCI. Alternatively, a HARQ process ID of each position is indicated in DCI.

In at least one embodiment, an RV used by each resource may be indicated by using a solution similar to the solution in Example 2.

By using the solution in Example 2, when multiple SPS PDSCHs exist in one SPS period, a HARQ process ID may be determined to ensure service transmission.

### Example 3

A solution in Example 3 is applicable to determining a HARQ process ID available to a CG PUSCH or an SPS PDSCH in a case in which more than one CG PUSCH or SPS PDSCH exists in one CG or SPS period. For example, only one of resources and a HARQ process of the resource are used in one period. A specific implementation procedure may include the following steps. It should be noted that an uplink CG is used as an example in the following step 1 and step 2, which is also applicable to a downlink SPS.

In step 1, a network configures a CG resource and a HARQ process corresponding to the CG resource.

In some embodiments, there may be multiple network configuration manners in a case in which more than one CG PUSCH or more than one CG transmission resource is included in one period of a CG resource.

In at least one embodiment, more than one CG PUSCH or more than one CG transmission resource is configured in one period, but a terminal device uses only one of the CG PUSCH or the CG transmission resource. An unused resource in a current period is considered invalid. In some embodiments, multiple CG PUSCHs or multiple CG transmission resources are FDM resources or TDM resources.

In at least one embodiment, more than one CG PUSCH or more than one CG transmission resource is configured in one period, and HARQ processes corresponding to different CG PUSCHs or different CG transmission resources are the same or different. Further, in some embodiments, more than one CG PUSCH or more than one CG transmission resource is configured in one period, and different CG PUSCHs or different CG transmission resources correspond to a same HARQ process or different HARQ processes. The terminal device uses only a HARQ process corresponding to one selected CG PUSCH or one selected CG transmission resource.

In at least one embodiment, if HARQ processes corresponding to all CG PUSCHs or all CG transmission resources are the same, the terminal device may calculate a HARQ process ID according to a specific resource position. For example, the specific resource position may be the first, the last, or the like.

In at least one embodiment, if HARQ processes corresponding to different CG PUSCHs or different CG transmission resources are different, HARQ process IDs obtained through calculation according to different positions are different. A HARQ process to be finally used depends on a CG PUSCH or a CG transmission resource that is finally used by the terminal device.

In step 2, a terminal device receives the CG resource and a HARQ configuration or indication that are configured by the network, determines a CG transmission resource to be used, determines a HARQ process, and performs transmission.

In at least one embodiment, more than one CG PUSCH or more than one CG transmission resource is configured in one period, but the terminal device uses only one of the CG PUSCH or the CG transmission resource.

In at least one embodiment, more than one CG PUSCH or more than one CG transmission resource is configured in one period, and different CG PUSCHs or different CG transmission resources correspond to a same HARQ process or different HARQ processes. The terminal device uses only a HARQ process corresponding to one selected CG PUSCH or one selected CG transmission resource.

In at least one embodiment, more than one CG PUSCH or more than one CG transmission resource is configured in one period. The terminal device calculates a HARQ process ID according to a position of each resource or a position of a specific resource (for example, the first or the last) in the one period.

In at least one embodiment, Example 3 may further include step 3. In step 3, the network determines, based on first information, that some CG positions are not used, and may be used by another terminal device.

In at least one embodiment, an RV used by each resource may be indicated by using a solution similar to the solution in Example 3.

In comparison with Example 1 and Example 2, the solution in Example 3 provides a method for using only one of resources and determining a HARQ process ID when multiple resources are configured in one CG or SPS period. An advantage of the solution in Example 3 is that an existing HARQ formula may be used as much as possible to reduce complexity.

### Example 4

In a solution in Example 4, a first node device may indicate data packet size information, or data rate information, or feature information of a flow that is of a network, where the data packet size information, or the data rate information, or the feature information of the flow may be used by the network to perform scheduling or configuration. It should be understood that the solution in Example 4 may be applied to uplink scheduling and/or downlink scheduling. A specific implementation procedure may include the following step 1 and step 2.

In step 1, the first node device indicates auxiliary information of the network, where the auxiliary information may include, for example, the data packet size information, or the data rate information, or the feature information of the flow.

In at least one embodiment, the data packet size information, or the data rate information, or the feature information of the flow is a value or an information change.

In at least one embodiment, the data packet size information, or the data rate information, or the feature information of the flow may be indicated by a period of time. For example, the period of time may indicate a corresponding time of the information, for example, at least one of a start time instant, duration (duration), and an end time instant.

In at least one embodiment, the data packet size information, or the data rate information, or the feature information of the flow may be information about a PDU session, a QoS flow, a service, a DRB, an LCH granularity, or a flow granularity.

In at least one embodiment, an SPS, a CG, or a DG is associated with a specific object, for example, associated with a PDU session, a QoS flow, a service, a DRB, an LCH, or a flow. In other words, only the corresponding PDU session, the corresponding QoS flow, the corresponding service, the corresponding DRB, the corresponding LCH, or the corresponding flow may be transmitted in the SPS, the CG, or the DG.

In at least one embodiment, the feature information of the flow may include, for example, multi-flow existence or indication information or change information of the multi-flow existence or indication information, feature information of each flow or change information of the feature information of each flow, and multi-flow feature information or change information of the multi-flow feature information.

In at least one embodiment, a first node may be a terminal device, a core network (for example, a UPF or an SMF), a server, a central control node, or the like.

In step 2, the network receives auxiliary information transmitted by the first node device, and performs scheduling or configuration. For example, the network may perform the following scheduling or configuration:
(a) adjusting scheduling, for example, executing dynamic scheduling and/or RRC parameter configuration based on latest auxiliary information; (b) adjusting resource allocation, for example, adjusting a pre-configured CG or a pre-configured SPS, or activating or deactivating a CG or an SPS according to latest auxiliary information; (c) if multiple CGs or SPSs are configured for a related service, a related LCH, or a related flow, or one CG or SPS is configured and multiple TB resources exist in one period of the configuration, the network may schedule some TBs for use by another terminal device.

The solution in Example 4 supports obtaining of auxiliary information. Based on the obtained auxiliary information, the network can adjust scheduling and a resource configuration, thereby reducing resource waste while ensuring service transmission.

### Example 5

A solution in Example 5 may be applicable to a case in which a data packet size or a data rate or feature information of a flow changes and a data packet is relatively large. In Example 5, the scenario may be covered by using multiple (multiple) CGs or SPSs. Because a quantity of indexes of existing CGs, SPSs, or HARQ processes is insufficient, the quantity of the indexes of the existing CGs, SPSs, or HARQ processes may be extended. It should be understood that the solution in Example 5 may be applied to uplink scheduling and/or downlink scheduling. A specific implementation procedure may include the following steps 1 and step 2.

In step 1, a network configures multiple CGs or SPSs.

In at least one embodiment, the quantity of the indexes of the existing CGs, the SPSs, or the HARQ processes may be extended.

In at least one embodiment, a CG or an SPS corresponds to a specific object, such as a PDU session, a QoS flow, a service, a DRB, an LCH, or a flow, that is, only the PDU session, or the QoS flow, or the service, or the DRB, or the LCH, or the flow may be transmitted in the SPS, the CG, or a DG.

In at least one embodiment, the network may determine, based on first information, whether to configure the multiple CGs or SPSs. The first information may be, for example, data packet size information, or data rate information, or feature information of a flow.

In at least one embodiment, the first information is information about a PDU session, a QoS flow, a service, a DRB, an LCH, or a flow granularity.

In at least one embodiment, the first information is an indication that a PDU session, a QoS flow, a service, a DRB, an LCH, a packet (packet), or a flow exists, and the indication may indicate that a data packet size or a data rate or feature information of a flow changes, and a data packet is relatively large.

In at least one embodiment, the feature information of the flow may include, for example, multi-flow existence or indication information or change information of the multi-flow existence or indication information, feature information of each flow or change information of the feature information of each flow, and multi-flow feature information or change information of the multi-flow feature information.

In step 2, a terminal device performs data transmission by using the multiple CGs or SPSs configured by the network.

In at least one embodiment, Example 5 may further include step 3. In step 3, the network determines, based on first information, that some CG or SPS positions are not used, to schedule the CG or SPS positions for use by another terminal device.

The network may determine, in multiple manners, that some CG or SPS positions are not used. In at least one embodiment, if some CGs or SPSs are not used, the terminal device may report indexes of the unused CGs or SPSs to the network, and the network may schedule transmission of another terminal device by using the information. In at least one embodiment, the network may determine, based on data packet size information or data rate information or feature information of a flow, a resource that is not to be used, to schedule transmission of another terminal device. For details about the information reporting manner, one may refer to the method in Example 4.

In at least one embodiment, a short CG or SPS period may be used to implement data transmission in which a data packet is variable or a data rate is variable and a data packet is relatively large. The solution in Example 5 may reuse an existing architecture, and therefore is simple.

The foregoing describes method embodiments of this application in detail with reference to FIG. 1 to FIG. 6. The following describes apparatus embodiments of this application in detail with reference to FIG. 7 to FIG. 12. It should be understood that the descriptions of the method embodiments correspond to the descriptions of the apparatus embodiments, and therefore, for parts that are not described in detail, one may refer to the foregoing method embodiments.

FIG. 7 is a schematic structural diagram of a terminal device according to an embodiment of this application. The terminal device 700 shown in FIG. 7 may include a first receiving module 710 and a transmitting module 720.

The first receiving module 710 may be configured to receive first information, where the first information is used to configure a first resource, the first resource is a configured grant CG resource or a semi-persistent scheduling SPS resource, multiple transmission resources are configured for first resource in one period, and/or, the first resource is a dynamic grant DG resource, and downlink control information DCI associated with the DG resource indicates multiple transmission resources.

The transmitting module 720 may be configured to perform data transmission by using at least one of the multiple transmission resources.

FIG. 8 is a schematic structural diagram of a terminal device according to another embodiment of this application. The terminal device 800 shown in FIG. 8 may include a first receiving module 810.

The first receiving module 810 may be configured to receive third information, where third information is used to configure at least one second resource, the second resource is a configured grant CG resource or a semi-persistent scheduling SPS resource, and one transmission resource is configured for second resource in one period.

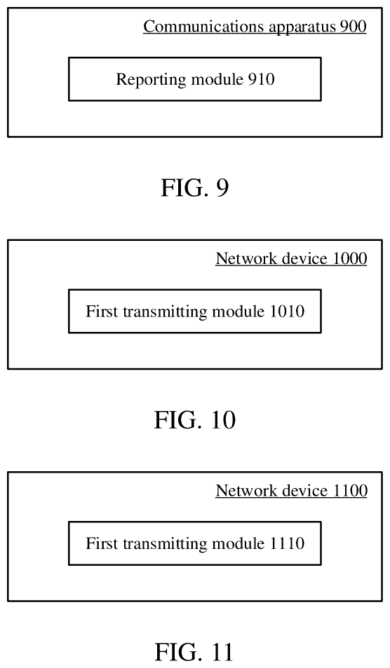

FIG. 9 is a schematic structural diagram of a communications apparatus according to an embodiment of this application. The communications apparatus 900 shown in FIG. 9 may be a first node device. The first node device includes a reporting module 910.

The reporting module 910 is configured to report auxiliary information, where the auxiliary information is used to indicate feature information of a target service, data, an LCH, a protocol data unit PDU, or a flow; or is used to indicate change information of the feature information of the target service, the data, the LCH, the PDU, or the flow; or is used to indicate changed request information; or is used to indicate that the feature information of the target service, the data, the LCH, the PDU, or the flow changes; or is used to indicate a level of a change of the feature information of the target service, the data, the LCH, the PDU, or the flow; or is used to indicate a rule of the feature information of the target service, the data, the LCH, the PDU, or the flow; or is used to indicate a requested resource configuration, or report data volume information that is expected to be received by a peer end or a network device, or report data volume information that is expected to arrive at a peer end or a network device.

FIG. 10 is a schematic structural diagram of a network device according to an embodiment of this application. The network device 1000 shown in FIG. 10 may include a first transmitting module 1010.

The first transmitting module 1010 may be configured to transmit first information to a terminal device, where the first information is used to configure a first resource, the first resource is a configured grant CG resource or a semi-persistent scheduling SPS resource, multiple transmission resources are configured for first resource in one period, and/or, the first resource is a dynamic grant DG resource, and downlink control information DCI associated with the DG resource indicates multiple transmission resources.

FIG. 11 is a schematic structural diagram of a network device according to another embodiment of this application. The network device 1100 shown in FIG. 11 may include a first transmitting module 1110.

The first transmitting module 1110 may be configured to transmit third information to a terminal device, where third information is used to configure at least one second resource, the second resource is a configured grant CG resource or a semi-persistent scheduling SPS resource, and one transmission resource is configured for the second resource in one period.

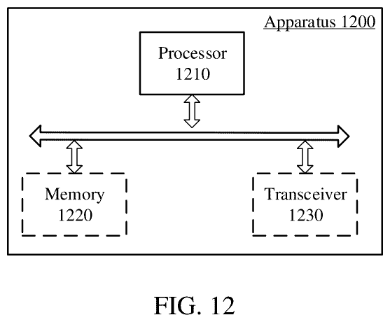

FIG. 12 is a schematic structural diagram of a communications apparatus according to an embodiment of this application. The dashed lines in FIG. 12 indicate that the unit or module is optional. The apparatus 1200 may be configured to implement the methods described in the method embodiments. The apparatus 1200 may be a chip, a terminal device, or a network device.

The apparatus 1200 may include one or more processors 1210. The processor 1210 may allow the apparatus 1200 to implement the methods described in the foregoing method embodiments. The processor 1210 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program that may be executed by the processor 1210 to cause the processor 1210 to execute the methods described in the foregoing method embodiments. The memory 1220 may be independent of the processor 1210 or may be integrated into the processor 1210.

The apparatus 1200 may further include a transceiver 1230. The processor 1210 may communicate with another device or chip by using the transceiver 1230. For example, the processor 1210 may transmit data to and receive data from another device or chip by using the transceiver 1230.

An embodiment of this application further provides a computer-readable storage medium for storing a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in various embodiments of this application.

An embodiment of this application further provides a computer program. The computer program may be applied to a terminal or a network device provided in embodiments of this application, and the computer program causes a computer to execute the methods to be executed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association between A and B.

In embodiments of this application, “B corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “pre-defining” and “pre-configuration” may be implemented by pre-storing a corresponding code or table in a device (for example, including the terminal device and the network device) or in other manners that may be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system. This is not limited in this application.

In embodiments of this application, the term “and/or” indicates merely an association that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined based on functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, multiple units or components may be combined or integrated into another system, or some features may be ignored or not executed. In addition, the displayed or discussed mutual couplings or direct couplings or communication connections may be implemented by using some interfaces. The indirect couplings or communication connections between apparatuses or units may be implemented in electrical, mechanical, or other forms.

The units described as separate components may be or may not be physically separated, and the components displayed as units may be or may not be physical units, that is, may be located in one place or distributed on multiple network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD), a semiconductor medium (for example, a solid-state drive (SSD), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A terminal device, comprising at least one processor, wherein the at least one processor is configured to:
receive first information, wherein the first information is used to configure a first resource, the first resource is a configured grant CG resource, multiple CG PUSCHs are configured for the first resource in one CG period; and
perform data transmission by using at least one of the multiple CG PUSCHs.

2. The terminal device according to claim 1, wherein the multiple CG PUSCHs correspond to at least one hybrid automatic repeat request HARQ process ID.

3. The terminal device according to claim 1, wherein the at least one processor is further configured to:
determine, by the terminal device, a HARQ process ID of the multiple CG PUSCHs in the one CG period.

4. The terminal device according to claim 3, wherein the HARQ process ID of the multiple CG PUSCHs in the one CG period is determined by the terminal device based on a pre-defined rule.

5. The terminal device according to claim 1, wherein a HARQ process ID of a first CG PUSCH in the multiple CG PUSCHs is related to a first factor, or is determined based on a first formula, and the first CG PUSCH is a specific CG PUSCH or any CG PUSCH in the multiple CG PUSCHs.

6. The terminal device according to claim 5, wherein the first factor comprises at least one of following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of logical channels LCH.

7. The terminal device according to claim 5, wherein the first resource is a CG resource, multiple CG physical uplink shared channels PUSCH are configured for the CG resource in one period, and the first formula is related to one or more of following items, or the first formula comprises at least one of following items:
a quantity of CG PUSCHs in one CG period;
a quantity of different HARQ process IDs that are to be used in one CG period;
a time domain start position of an uplink CG resource;
a quantity of HARQ process IDs of the first CG PUSCH;
an offset of a HARQ process of the first CG PUSCH;
a quantity of HARQ processes of the first resource; or
an offset of a HARQ process of the first resource.

8. The terminal device according to claim 7, wherein the first formula comprises one or more of following:
HARQ process ID of the first transmission resource M*{[floor (CURRENT_symbol/periodicity)] modulo nrofHARQ-processes}; or
HARQ process ID of the first transmission resource M*{[floor (CURRENT_symbol/periodicity)] modulo nrofHARQ-processes+harq-procID-Offset2};
wherein M is the quantity of the CG PUSCHs in the one CG period, or M is the quantity of the different HARQ process IDs that are to be used in the one CG period, CURRENT_symbol is the time domain start position of the uplink CG resource, nrofHARQ-processes is the quantity of the HARQ processes of the first resource, and harq-procID-Offset2 is the offset of the HARQ process of the first resource.

9. The terminal device according to claim 5, wherein a HARQ process ID of another transmission resource in the multiple transmission resources except the first transmission resource is related to a second factor, or is determined based on a second formula.

10. The terminal device according to claim 9, wherein the second factor comprises at least one of following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, an offset of the another transmission resource relative to the first transmission resource, a quantity of flows, or a quantity of LCHs.

11. The terminal device according to claim 5, wherein a HARQ process ID of another transmission resource in the multiple transmission resources except the first transmission resource is the HARQ process ID of the first transmission resource plus an offset of the another transmission resource relative to the first transmission resource.

12. The terminal device according to claim 9, wherein the first resource is a CG resource, multiple CG PUSCHs are configured for the CG resource in one period, and the second formula is related to one or more of following items, or the second formula comprises at least one of following items:
a quantity of CG PUSCHs in one CG period;
a quantity of different HARQ process IDs that are to be used in one CG period;
a time domain start position of an uplink CG resource;
a quantity of HARQ processes of the first resource;
an offset of a HARQ process of the first resource;
a quantity of HARQ process IDs of the first transmission resource;
an offset of a HARQ process of the first transmission resource; or
an offset of the another transmission resource relative to the first transmission resource.

13. The terminal device according to claim 12, wherein the second formula comprises one or more of following:
HARQ process ID of the another transmission resource M*{[floor (CURRENT_symbol/periodicity)] modulo nrofHARQ-processes}+offset N; or
HARQ process ID of the another transmission resource M*{[floor (CURRENT_symbol/periodicity)] modulo nrofHARQ-processes+harq-procID-Offset2}+offset N;
wherein M is the quantity of the CG PUSCHs in the one CG period, or M is the quantity of the different HARQ process IDs that are to be used in the one CG period, CURRENT_symbol is the time domain start position of the uplink CG resource, nrofHARQ-processes is the quantity of the HARQ processes of the first resource, harq-procID-Offset2 is the offset of the HARQ process of the first resource, and offset N is the offset of the another transmission resource relative to the first transmission resource.

14. A network device, comprising at least one processor, wherein the at least one processor is configured to:
transmit first information to a terminal device, wherein the first information is used to configure a first resource, the first resource is a configured grant CG resource, multiple CG PUSCHs are configured for the first resource in one CG period.

15. The network device according to claim 14, wherein the multiple CG PUSCHs correspond to at least one hybrid automatic repeat request HARQ process ID.

16. The network device according to claim 14, wherein the HARQ process ID of the multiple CG PUSCHs in the one CG period is determined by the terminal device based on a pre-defined rule.

17. The network device according to claim 14, wherein a HARQ process ID of a first CG PUSCH in the multiple CG PUSCHs is related to a first factor, or is determined based on a first formula, and the first CG PUSCH is a specific CG PUSCH or any CG PUSCH in the multiple CG PUSCHs.

18. The network device according to claim 17, wherein the first factor comprises at least one of following: a quantity of resources that are concurrently scheduled, a quantity of HARQ processes corresponding to a scheduled resource, a quantity of resources in one period, a quantity of HARQ process IDs that are to be used in one period, a time domain start position of a resource, a quantity of HARQ processes corresponding to a resource, an offset of a HARQ process corresponding to a resource, a quantity of flows, or a quantity of logical channels LCH.

19. The network device according to claim 17, wherein the first resource is a CG resource, multiple CG physical uplink shared channels PUSCH are configured for the CG resource in one period, and the first formula is related to one or more of following items, or the first formula comprises at least one of following items:
a quantity of CG PUSCHs in one CG period;
a quantity of different HARQ process IDs that are to be used in one CG period;
a time domain start position of an uplink CG resource;
a quantity of HARQ process IDs of the first transmission resource;
an offset of a HARQ process of the first transmission resource;
a quantity of HARQ processes of the first resource; or
an offset of a HARQ process of the first resource.

20. A communication method, comprising:
receiving, by a terminal device, first information, wherein the first information is used to configure a first resource, the first resource is a configured grant CG resource, multiple CG PUSCHs are configured for the first resource in one CG period; and
performing, by the terminal device, data transmission by using at least one of the multiple CG PUSCHs.
